(19) United States
(12) Patent Application Publication
(10) Pub. No.: US 2026/0197366 A1
(43) Pub. Date: Jul. 9, 2026

(54) MULTI-READER AMBIENT INTERNET OF THINGS OPERATION

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US)

(21) Appl. No.: 19/012,357

(22) Filed: Jan. 7, 2025

(51) Int. Cl. H04L 67/12

(52) U.S. Cl. CPC H04L 67/12

(57) ABSTRACT

Various aspects of the present disclosure generally relate to wireless communication. In some aspects, a network commander device may receive capability information associated with a plurality of ambient internet of things (A-IoT) reader devices, the capability information indicating a respective A-IoT reader category for each A-IoT reader device of the plurality of A-IoT reader devices. The network commander device may transmit, to the plurality of A-IoT reader devices, at least one of configuration information or scheduling information based at least in part on the capability information. Numerous other aspects are described.

### FIELD OF THE DISCLOSURE

Aspects of the present disclosure generally relate to wireless communication and specifically relate to techniques, apparatuses, and methods associated with multi-reader ambient internet of things (A-IoT) operation.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a network commander device for wireless communication. The network commander device may include one or more memories and one or more processors coupled to the one or more memories. The one or more processors may be individually or collectively configured to receive capability information associated with a plurality of ambient internet of things (A-IoT) reader devices, the capability information indicating a respective A-IoT reader category for each A-IoT reader device of the plurality of A-IoT reader devices. The one or more processors may be individually or collectively configured to transmit, to the plurality of A-IoT reader devices, at least one of configuration information or scheduling information based at least in part on the capability information.

Some aspects described herein relate to an A-IoT reader device for wireless communication. The A-IoT reader device may include one or more memories and one or more processors coupled to the one or more memories. The one or more processors may be individually or collectively configured to transmit, to a network commander device, capability information associated with the A-IoT reader device, the capability information indicating an A-IoT reader category for the A-IoT reader device. The one or more processors may be individually or collectively configured to receive, from the network commander device, at least one of configuration information or scheduling information based at least in part on the capability information.

Some aspects described herein relate to a method of wireless communication performed by a network commander device. The method may include receiving capability information associated with a plurality of A-IoT reader devices, the capability information indicating a respective A-IoT reader category for each A-IoT reader device of the plurality of A-IoT reader devices. The method may include transmitting, to the plurality of A-IoT reader devices, at least one of configuration information or scheduling information based at least in part on the capability information.

Some aspects described herein relate to a method of wireless communication performed by an A-IoT reader device. The method may include transmitting, to a network commander device, capability information associated with the A-IoT reader device, the capability information indicating an A-IoT reader category for the A-IoT reader device. The method may include receiving, from the network commander device, at least one of configuration information or scheduling information based at least in part on the capability information.

Some aspects described herein relate to a non-transitory computer-readable medium that stores a set of instructions for wireless communication by a network commander device. The set of instructions, when executed by one or more processors of the network commander device, may cause the network commander device to receive capability information associated with a plurality of ambient internet of things (A-IoT) reader devices, the capability information indicating a respective A-IoT reader category for each A-IoT reader device of the plurality of A-IoT reader devices. The set of instructions, when executed by one or more processors of the network commander device, may cause the network commander device to transmit, to the plurality of A-IoT reader devices, at least one of configuration information or scheduling information based at least in part on the capability information.

Some aspects described herein relate to a non-transitory computer-readable medium that stores a set of instructions for wireless communication by an A-IoT reader device. The set of instructions, when executed by one or more processors of the A-IoT reader device, may cause the A-IoT reader device to transmit, to a network commander device, capability information associated with the A-IoT reader device, the capability information indicating an A-IoT reader category for the A-IoT reader device. The set of instructions, when executed by one or more processors of the A-IoT reader device, may cause the A-IoT reader device to receive, from the network commander device, at least one of configuration information or scheduling information based at least in part on the capability information.

Some aspects described herein relate to an apparatus for wireless communication. The apparatus may include means for receiving capability information associated with a plurality of A-IoT reader devices, the capability information indicating a respective A-IoT reader category for each A-IoT reader device of the plurality of A-IoT reader devices. The apparatus may include means for transmitting, to the plurality of A-IoT reader devices, at least one of configuration information or scheduling information based at least in part on the capability information.

Some aspects described herein relate to an apparatus for wireless communication. The apparatus may include means for transmitting, to a network commander device, capability information associated with the apparatus, the capability information indicating an A-IoT reader category for the apparatus. The apparatus may include means for receiving, from the network commander device, at least one of configuration information or scheduling information based at least in part on the capability information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples associated with different types of ambient internet of things (A-IoT) devices, in accordance with the present disclosure.

FIG. 4 is a diagram illustrating an example associated with backscatter communications, in accordance with the present disclosure.

FIG. 5 is a diagram illustrating examples of topologies for A-IoT devices, in accordance with the present disclosure.

FIG. 6 is a diagram illustrating an example of interference in an A-IoT system, in accordance with the present disclosure.

FIG. 7 is a diagram illustrating an example associated with multi-reader A-IoT operation, in accordance with the present disclosure.

FIGS. 8A-8C are diagrams illustrating examples associated with grouping of readers for multi-reader A-IoT operation, in accordance with the present disclosure.

FIGS. 9A-9D are diagrams illustrating examples associated with cooperative communication schemes for multi-reader A-IoT operation, in accordance with the present disclosure.

FIG. 10 is a diagram illustrating an example process performed, for example, at a network commander device or an apparatus of a network commander device, in accordance with the present disclosure.

FIG. 11 is a diagram illustrating an example process performed, for example, at an A-IoT reader device or an apparatus of an A-IoT reader device, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set

forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless communications device (e.g., a user equipment (UE) or other wireless communication device) may be an Internet of Things (IoT) device. Some IoT devices, such as ambient IoT (A-IoT) devices (sometimes referred to as ultra-light IoT devices), may be associated with a relatively simple hardware design that may be designed to use low power and be implementable at low cost. A-IoT technology may include passive IoT (such as New Radio (NR) passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive (or semi-passive) IoT device referred to as an “ambient backscatter device” or a “backscatter device,” which may modulate by reflecting radio signals from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications. In some examples, an A-IoT device may communicate with a reader (for example, a UE, a network node, or a network entity) by modulating or reflecting a radio signal from a radio frequency (RF) source (for example, the reader, a network node, a UE, or another network entity).

In some examples, an A-IoT system may be deployed with multiple A-IoT reader devices (also referred to as “readers”). An A-IoT reader device (e.g., a reader) is a device that communicates with (e.g., transmits a signal to and/or receives a signal from) one or more A-IoT devices. For example, an A-IoT reader device (or reader) may be a network node, a UE, an intermediate node, and/or an assisting node, among other examples. In some examples, an A-IoT system deployed with multiple readers may include one or more stationary readers that are fixed at certain locations and/or one or more mobile readers capable of moving to different locations. The A-IoT system may include one or more A-IoT devices. The readers and the one or more A-IoT devices may be physically dispersed throughout the A-IoT system.

In some examples, the A-IoT system may include a network commander. The network commander may be configured to support the A-IoT system. The network commander may be central control unit (e.g., a controller) configured to manage the A-IoT system. For example, the network commander may be a reader controller configured to manage, configure, and/or otherwise support the readers in the A-IoT system. In some examples, the network commander may schedule and coordinate communications of all the readers and/or collect data received (e.g., from one or more A-IoT devices) by the readers. In some examples, the network commander may be, or may be included in, a network node. In some other examples, the network commander may be, or may be included in, a UE.

In some examples, the readers may operate in different modes to perform different actions for communicating with the one or more A-IoT devices depending on scheduling decisions by the network commander. For example, a reader may transmit an energy harvesting (EH) signal to provide energy to an A-IoT device, transmit a reader-to-device (R2D) command to an A-IoT device, transmit a carrier wave (CW) signal to an A-IoT device, and/or receive a device-to-reader (D2R) response transmitted by an A-IoT device. The A-IoT device may transmit the D2R response by reflecting a signal received via a forward link (e.g., the CW signal) as a backscatter signal.

In an A-IoT deployment, deploying multiple readers (e.g., multiple A-IoT reader devices) may be desirable to enhance the coverage of the A-IoT deployment and/or to provide positioning services for A-IoT devices. For example, deploying multiple readers may allow for coverage enhancement by enabling bi-static A-IoT communications and increasing a range of communications with the A-IoT devices (e.g., due to a signal boost resulting from signals being transmitted from multiple readers). To maximize the performance gain from deploying multiple readers, it may be desirable for the readers to operate in a synchronized fashion so as not to cause interference with each other and to enable load balancing. However, the readers may have different capabilities (e.g., local clock accuracy, Tx power, and/or carrier frequency accuracy capabilities, among other examples) and/or include different categories of A-IoT reader devices, which are not considered by the network commander when coordinating scheduling for the readers. As a result, performance gains from deploying multiple readers may be limited.

Various aspects relate generally to multi-reader A-IoT operation. Some aspects more specifically relate to configuration and scheduling of multiple A-IoT reader devices for cooperative communications with one or more A-IoT devices. In some aspects, a network commander may receive capability information associated with a plurality of A-IoT reader devices. The capability information may indicate a respective A-IoT reader category for each A-IoT reader device of the plurality of A-IoT reader devices. The network commander may transmit, to the plurality of A-IoT reader devices, configuration information and/or scheduling information based at least in part on the capability information.

Particular aspects of the subject matter described in this disclosure can be implemented to realize one or more of the following potential advantages. In some examples, by the network commander receiving the capability information including the respective A-IoT categories associated with the plurality of-IoT reader devices and transmitting configuration and/or scheduling information based at least in part on the capability information, the described techniques can be used to enable the network commander to consider the capabilities, including the A-IoT categories, of the plurality of-IoT reader devices when configuring and/or scheduling the A-IoT reader devices to perform collaborative communication with one or more A-IoT devices. In this way, synchronization between the A-IoT reader devices may be improved, resulting in reduced interference and improved load balancing, and performance gains associated with deploying multiple A-IoT reader devices, such as enhanced coverage range, may be increased.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

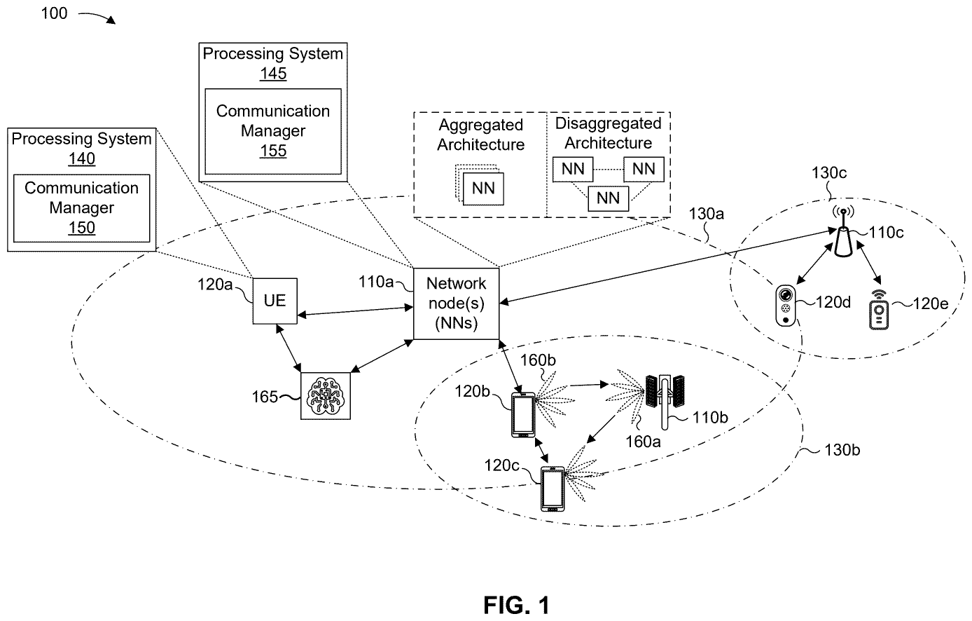

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

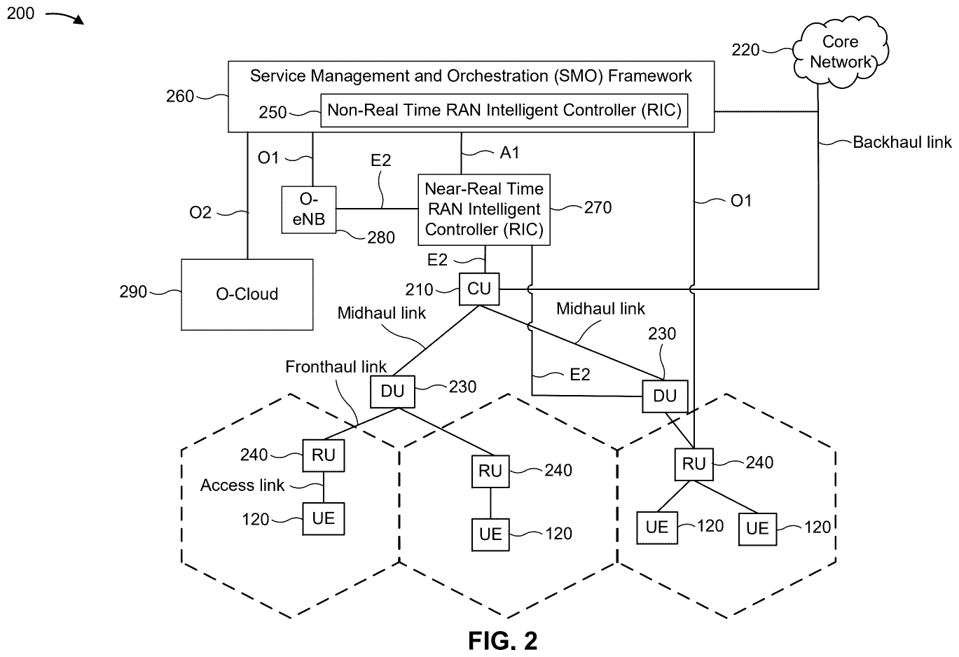

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d and/or the UE 120e may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IoT (narrowband IoT) devices, such as the UE 120d and/or the UE 120e An IoT or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment (CPEs), which may include telecommunications devices that are installed at a customer location (such as a home or office) to enable access to a service provider's network (such as included in or in communication with the wireless communication network 100).

Some IoT devices, such as A-IoT devices (sometimes referred to as ultra-light IoT devices), may be associated with a relatively simple hardware design that may be designed to use low power and be implementable at low cost. For example, the UE 120d and/or the UE 120e may be A-IoT devices. As shown in FIG. 2, an A-IoT device may operate in the cell 130c, which may be referred to herein as an “A-IoT system” or an “A-IoT network.” The A-IoT device(s) may communicate with the network node 110c. For example, the network node 110c may be a reader (e.g., an A-IoT reader device). In other examples, the A-IoT devices may communicate with one or more other readers. A reader (e.g., an A-IoT reader device) may be a network node 110, a UE 120, or another wireless communication device. A-IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications. As an example, the cell 130c may be associated with a home network, a factory network, and/or a building network, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the network node 110 may include a communication manager 155. As described in more detail elsewhere herein, the communication manager 155 may receive capability information associated with a plurality of A-IoT reader devices, the capability information indicating a respective A-IoT reader category for each A-IoT reader device of the plurality of A-IoT reader devices; and transmit, to the plurality of A-IoT reader devices, at least one of configuration information or scheduling information based at least in part on the capability information.

Additionally, or alternatively, as described in more detail elsewhere herein, the communication manager 155 may transmit, to a network commander device, capability information associated with an A-IoT reader device, the capability information indicating an A-IoT reader category for the A-IoT reader device; and receive, from the network commander device, at least one of configuration information or scheduling information based at least in part on the capability information. Additionally, or alternatively, the communication manager 155 may perform one or more other operations described herein.

In some aspects, the UE 120 may include a communication manager 150. As described in more detail elsewhere herein, the communication manager 155 may transmit, to a network commander device, capability information associated with an A-IoT reader device, the capability information indicating an A-IoT reader category for the A-IoT reader device; and receive, from the network commander device, at least one of configuration information or scheduling information based at least in part on the capability information.

Additionally, or alternatively, as described in more detail elsewhere herein, the communication manager 150 may receive capability information associated with a plurality of A-IoT reader devices, the capability information indicating a respective A-IoT reader category for each A-IoT reader device of the plurality of A-IoT reader devices; and transmit, to the plurality of A-IoT reader devices, at least one of configuration information or scheduling information based at least in part on the capability information. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

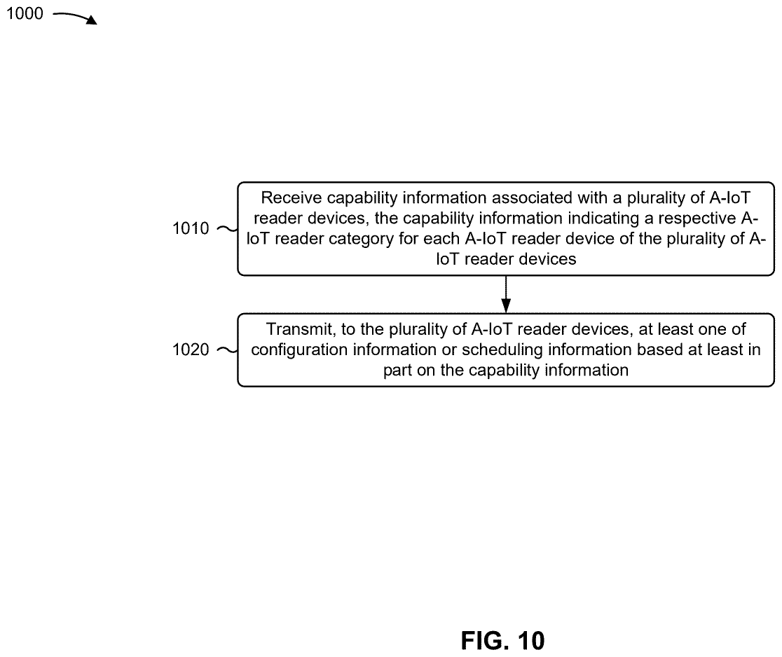

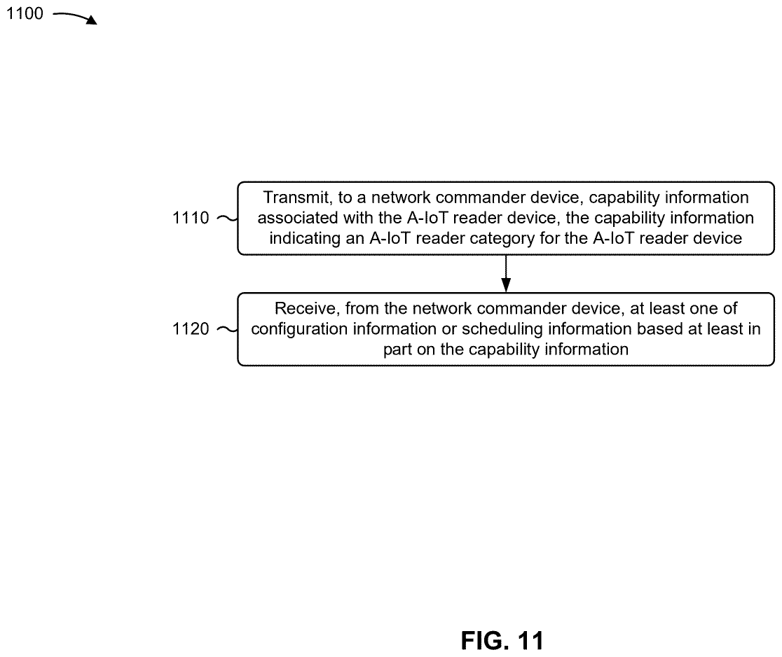

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with multi-reader A-IoT operation, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). In some aspects, the network commander device described herein is the network node 110, is included in the network node 110, or includes one or more components of the network node 110 described in connection with FIG. 1. In some aspects, the network commander device described herein is the UE 120, is included in the UE 120, or includes one or more components of the UE 120 described in connection with FIG. 1. In some aspects, the A-IoT reader device described herein is the network node 110, is included in the network node 110, or includes one or more components of the network node 110 described in connection with FIG. 1. In some aspects, the A-IoT reader device described herein is the UE 120, is included in the UE 120, or includes one or more components of the UE 120 described in connection with FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

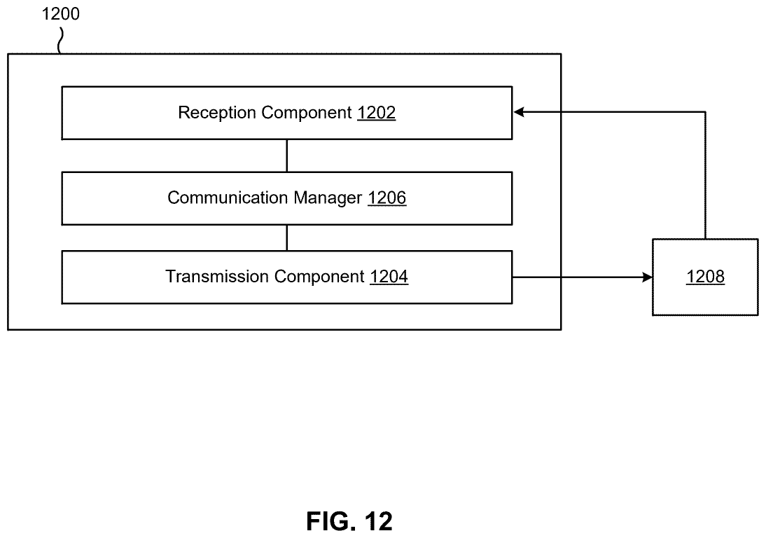

In some aspects, a network commander device includes means for receiving capability information associated with a plurality of A-IoT reader devices, the capability information indicating a respective A-IoT reader category for each A-IoT reader device of the plurality of A-IoT reader devices; and/or means for transmitting, to the plurality of A-IoT reader devices, at least one of configuration information or scheduling information based at least in part on the capability information. In some aspects, the means for the network commander device to perform operations described herein may include, for example, one or more of a communication manager (e.g., communication manager 155 or communication manager 150), a processing system (e.g., processing system 145 or processing system 140), a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

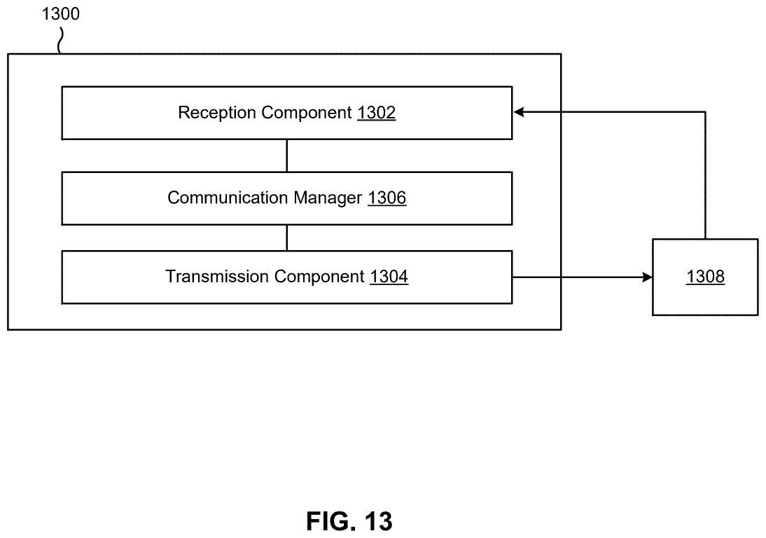

In some aspects, an A-IoT reader device includes means for transmitting, to a network commander device, capability information associated with the A-IoT reader device, the capability information indicating an A-IoT reader category for the A-IoT reader device; and/or means for receiving, from the network commander device, at least one of configuration information or scheduling information based at least in part on the capability information. In some aspects, the means for the A-IoT reader device to perform operations described herein may include, for example, one or more of a communication manager (e.g., communication manager 155 or communication manager 150), a processing system (e.g., processing system 145 or processing system 140), a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

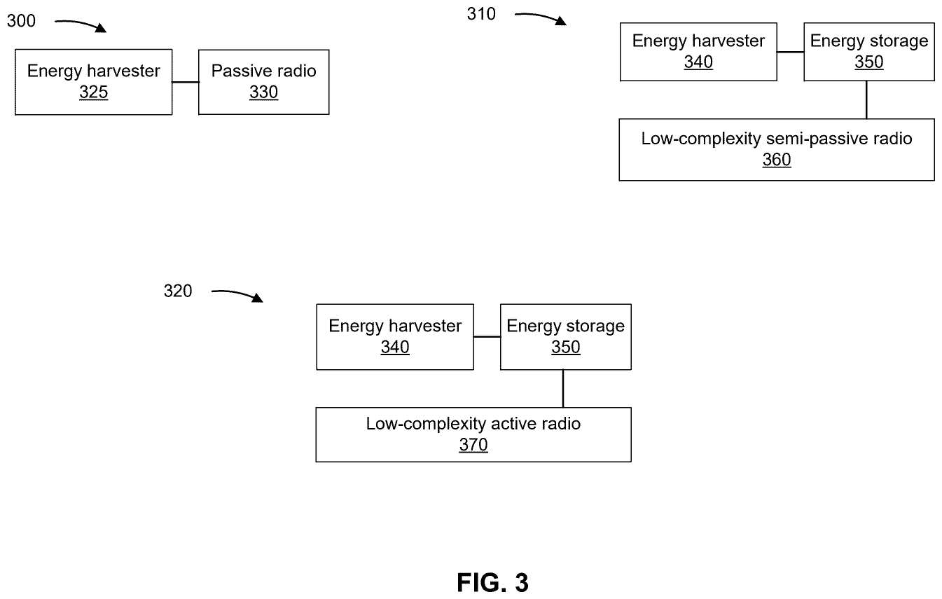

FIG. 3 is a diagram illustrating examples 300, 310, and 320 associated with different types of ambient IoT devices, in accordance with the present disclosure.

Example 300 illustrates components of a passive ambient IoT device. As shown, passive ambient IoT devices may include an energy harvester 325 and a passive radio 330. For example, the passive radio 330 may be configured to backscatter a CW. For example, passive ambient IoT devices may not include energy storage. The passive ambient IoT devices may harvest energy (e.g., via the energy harvester 325) to power the passive radio 330 to enable the passive radio 330 to perform reception and transmission operations.

Example 310 illustrates components of a semi-passive ambient IoT device. As shown, semi-passive ambient IoT devices may include an energy harvester 340, an energy storage 350, and/or a low-complexity semi-passive radio 360. For example, the low-complexity semi-passive radio 360 may be configured to harvest energy from a CW using the energy harvester 340, store energy from a CW using the energy storage 350, and/or backscatter a CW.

Example 320 illustrates components of an active ambient IoT device. As shown, active ambient IoT devices may include an energy harvester 340, an energy storage 350, and/or a low-complexity (for example, low-cost) active radio 370. For example, the low-complexity active radio 370 may be configured to harvest energy from a CW using the energy harvester 340, store energy from a CW using the energy storage 350, and/or backscatter a CW.

Ambient IoT devices may be categorized into at least three types of devices: device 1, device 2a, and device 2b. Device 1 type ambient IoT devices may include at least some passive and/or semi-passive devices. A device 1 type ambient IoT device may have approximately 1 microwatt (μW) peak power consumption, support energy storage, use an initial sampling frequency offset (SFO) up to 10^{X} ppm (for example, where X can be any suitable value), and communicate uplink transmissions by backscattering externally-provided CWs.

Device 2a type ambient IoT devices may include at least some semi-passive devices, and device 2b type ambient IoT devices may include active devices. Both device 2a and device 2b type ambient IoT devices may have less than or equal to a few hundred μW peak power consumption, support energy storage, and use an initial SFO up to 10^{X} ppm. A device 2a type ambient IoT device may communicate uplink transmissions by backscattering externally-provided CWs. A device 2b type ambient IoT device may communicate uplink transmissions by internally generating the uplink transmission.

In some examples, device 1, device 2a, and/or device 2b type ambient IoT devices that are located indoors may support a maximum distance of 10-50 m, a range which may be sub-selected. In Topology 1 (for example, in which an ambient IoT device may directly and bidirectionally communicate with one or more network nodes 110) and in Topology 2 (for example, in which an ambient IoT device may communicate bidirectionally with an intermediate node between the ambient IoT device and a network node 110), device 1, device 2a, and/or device 2b type ambient IoT devices may not support RRC states, mobility (for example, cell-selection/re-selection-like functionality), automatic repeat request (ARQ), or HARQ.

As indicated above, FIG. 3 is provided as an example. Other examples may differ from what is described with respect to FIG. 3.

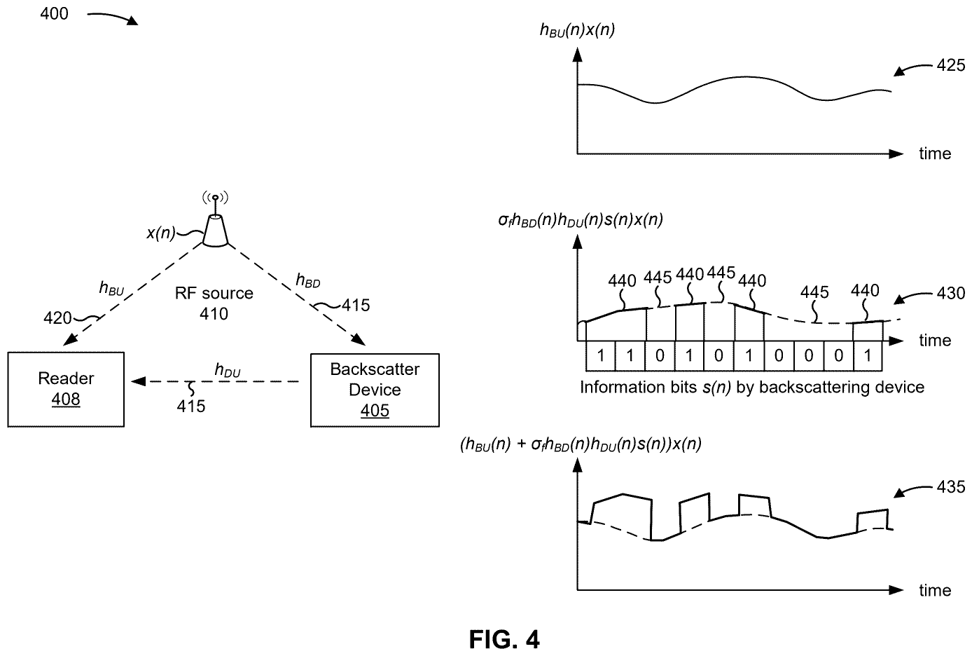

FIG. 4 is a diagram illustrating an example 400 associated with backscatter communications, in accordance with the present disclosure.

Some wireless communication devices may be considered IoT devices, such as ambient IoT devices (sometimes referred to as ultra-light IoT devices), or similar IoT devices. In ambient IoT, a terminal (for example, a radio frequency identification (RFID) device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 4, a backscatter device 405 (for example, a tag or a sensor, among other examples), which may be one example of an ambient IoT device such as a passive, semi-passive, or active ambient IoT device described with regard to FIG. 1 and FIG. 4, may employ a simplified hardware design (for example, including a power splitter, an energy harvester, and a microcontroller) that does not include a battery. For example, the backscatter device 405 may rely on energy harvesting for power and that may not include a radio wave generation circuit. In some examples, that the backscatter device 405 may be capable of transmitting information only by reflecting a radio wave. More particularly, the backscatter device 405 communicates with a reader 408 (for example, a UE 120, a network node 110 (e.g., the network node 110c), a network entity, or another network device) by modulating a reflecting radio signal from an RF source 410 (for example, a network node 110, a UE 120, or another network device). In some examples, the RF source 410 and the reader 408 may be the same device and/or may be co-located. For example, in some instances, the reader 408 and the RF source 410 may be associated with the same network node 110. In some examples, the backscatter device 405 may be referred to herein as a UE, such as a UE 120 (e.g., the UE 120d or the UE 120e).

To facilitate communication of the backscatter device 405, the RF source 410 may transmit an energy harvesting wave to the backscatter device 405. The energy harvesting wave may be transmitted for a sufficient duration in order to enable a communication phase for a target range between the reader 408 and the backscatter device 405. Additionally, or alternatively, in some instances, a range between the RF source 410 and the backscatter device 405 may be limited by a minimum received power for triggering energy harvesting at the backscatter device 405, such as −20 decibel milliwatts (dBm).

Once energy is sufficiently accumulated at the backscatter device 405, the backscatter device 405 may begin to reflect the radio wave that is radiated onto the backscatter device 405 via a backscatter link 415. For example, the RF source 410 may initiate a communication session (sometimes referred to as a query-response communication) with a query, which may be a modulating envelope of a CW. The backscatter device 405 may respond by backscattering of the CW. The communication session may include multiple rounds, such as for purposes of contention resolution when multiple backscatter devices respond to a query. A channel between the RF source 410 and the backscatter device 405 of the backscatter link 415 may be associated with a first backscatter link channel response value (sometimes referred to as a first backscatter link channel coefficient or a first backscatter link gain value), hBD. As described below, the backscatter device 405 may have reflection-on periods and reflection-off periods that follow a pattern that is based at least in part on the transmission of information bits by the backscatter device 405. The reader 408 may detect the reflection pattern of the backscatter device 405 and obtain the backscatter communication information via the backscatter link 415. A channel between the reader 408 and the backscatter device 405 of the backscatter link 415 may be associated with a second backscatter link channel response value (sometimes referred to as a second backscatter link channel coefficient or a second backscatter link channel gain value), hDU. In addition, the RF source 410 and the reader 408 may communicate (for example, reference signals and/or data signals) via a direct link 420. A channel between the RF source 410 and the reader 408 of the direct link 420 may be associated with a direct link channel response value (sometimes referred to as a direct link channel coefficient or a direct link channel gain value), hBU shown by reference number 425.

Thus, the resulting signal received at the reader 408, which is the superposition of the signal received via the direct link 420 and the signal received via the backscatter link 415, may be denoted as y(n). This signal, y(n), is shown by reference number 435. As shown, when s(n)=0 (indicated by reference number 440 in the plot shown at reference number 430), the backscatter device 405 may switch off reflection, and thus the reader 408 receives only the direct link 420 signal. When s(n)=1 (indicated by reference number 445 in the plot shown at reference number 430), the backscatter device 405 may switch on reflection, and thus the reader 408 receives a superposition of both the direct link 420 signal and the backscatter link 415 signal. To receive the information bits transmitted by the backscatter device 405, the reader 408 may first decode x(n) based at least in part on the direct link channel response value of hBU(n) by treating the backscatter link 415 signal as interference. The reader 408 may then detect the existence of the signal component.

As indicated above, FIG. 4 is provided as an example. Other examples may differ from what is described with respect to FIG. 4.

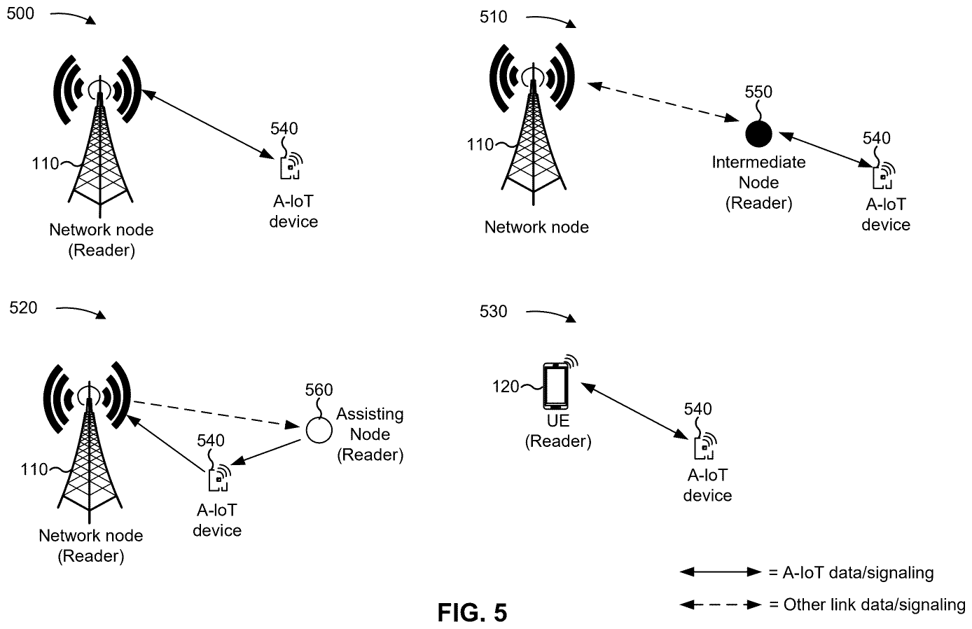

FIG. 5 is a diagram illustrating examples of topologies for ambient IoT devices, in accordance with the present disclosure. For example, FIG. 5 shows a first topology 500, a second topology 510, a third topology 520, and a fourth topology 530. These topologies are provided as examples and A-IoT devices may be deployed in a wireless communication network (e.g., the wireless communication network 100) in other topologies in accordance with the aspects and techniques described herein. FIG. 5 shows communication between an A-IoT device 540 (e.g., an A-IoT device similar to the device(s) described in connection with FIGS. 4 and 5) and a reader (for example, a network node 110, an intermediate node 550, an assisting node 560, and/or a UE 120, depending on the topology). The topologies depicted in FIG. 5 may be examples of A-IoT systems. For example, the topologies may be deployed in a wireless communication network (e.g., the wireless communication network 100), such as via the cell 130c.

The first topology 500 may be referred to as Topology 1. In Topology 1, the A-IoT device 540 may directly and bidirectionally communicate with one or more network nodes 110. For example, the A-IoT device 540 device and the one or more network nodes 110 may communicate A-IoT data and/or signaling. In some examples, a first network node 110 may transmit communications to the A-IoT device 540 and a second network node 110 may receive communications from the A-IoT device 540. In examples in which the A-IoT device 540 is deployed via the Topology 1, the network node 110 may be referred to as a reader (e.g., a reader as described in more detail elsewhere herein). For example, the Topology 1 may be a network node-based (or gNB-based) reader topology.

The second topology 510 may be referred to as Topology 2. In Topology 2, the A-IoT device 540 may communicate bidirectionally with an intermediate node 550 between the A-IoT device 540 and a network node 110. The intermediate node 550 may be any suitable device that is capable of A-IoT-based communication, such as a relay, an IAB node, UE (for example, a UE 120), a network node (e.g., a network node 110), or repeater, among other examples. The intermediate node 550 may transfer A-IoT data and/or signaling between network node 110 and the A-IoT device. In examples in which the A-IoT device 540 is deployed via the Topology 2, the intermediate node 550 may be referred to as a reader (e.g., a reader as described in more detail elsewhere herein). The intermediate node 550 and the network node 110 may communicate via another link, such as an access link, a backhaul link, a midhaul link, a fronthaul link, or another communication link (e.g., and may communicate data and/or signaling (e.g., control signaling) via the other link). In some examples, in the Topology 1, the network node 110 may be referred to as a controller, such as a reader controller.

The third topology 520 may be referred to as Topology 3. In some examples, in Topology 3, the A-IoT device 540 device may transmit A-IoT data and/or signaling to a network node 110 and receive A-IoT data and/or signaling from an assisting node 560. In some examples, in Topology 3, the A-IoT device 540 may receive A-IoT data and/or signaling from the network node 110 and transmit A-IoT data and/or signaling to the assisting node 560. The assisting node may be any suitable device that is capable of ambient IoT, such as a relay, an IAB node, UE (for example, a UE 120), a network node (e.g., a network node 110), or repeater, among other examples. In examples in which the A-IoT device 540 is deployed via the Topology 3, both the network node 110 and the assisting node 560 may be referred to as a reader (e.g., a reader as described in more detail elsewhere herein). The assisting node 560 and the network node 110 may communicate via another link, such as an access link, a backhaul link, a midhaul link, a fronthaul link, or another communication link (e.g., and may communicate data and/or signaling (e.g., control signaling) via the other link).

The fourth topology 530 may be referred to as Topology 4. In Topology 4, the A-IoT device 540 may bidirectionally communicate with a UE (e.g., a UE 120). For example, the A-IoT device 540 and the UE 120 may communicate A-IoT data and/or signaling. In examples in which the A-IoT device 540 is deployed via the Topology 4, the UE 120 may be referred to as a reader (e.g., a reader as described in more detail elsewhere herein).

As indicated above, FIG. 5 is provided as an example. Other examples may differ from what is described with respect to FIG. 5.

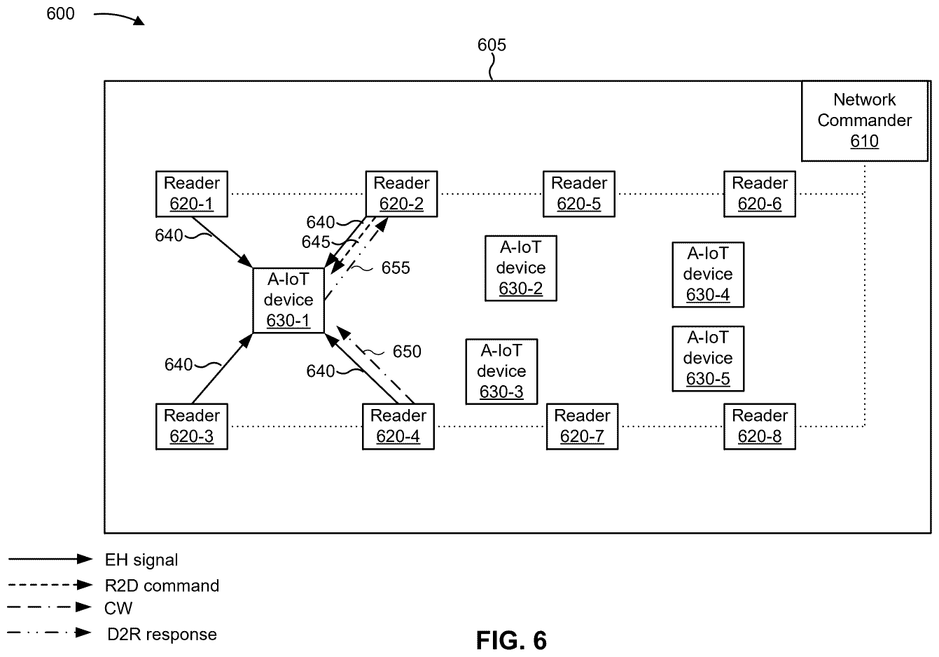

FIG. 6 is a diagram illustrating an example 600 of interference in an A-IoT system 605, in accordance with the present disclosure. The A-IoT system 605 may be, or may be included in, a wireless communication system, such as the wireless communication network 100. The A-IoT system 605 may include a cell, such as the cell 130c. In some example, the A-IoT system 605 may be associated with a geographic area, such as a building, a warehouse, a factory, and/or a home, among other examples. In some examples, the A-IoT system 605 may be an indoor system configured to provide wireless connectivity within an indoor area, such as within a building, a warehouse, a factory, and/or a home, among other examples.

As shown in FIG. 6, the A-IoT system 605 may include a network commander 610 and multiple readers 620 (shown as reader 620-1 through reader 620-8). For example, the A-IoT system 605 may include a network of readers 620. The readers 620 may be A-IoT reader devices. In some examples, a reader 620 (e.g., an A-IoT reader device) may be a network node 110, a UE 120, an intermediate node (e.g., the intermediate node 550), and/or an assisting node (e.g., the assisting node 560), among other examples. In some examples, one or more of the readers 620 may be similar to the reader 408 and/or the RF source 410 discussed in connection with FIG. 4. In some examples, the A-IoT system 605 may be deployed one or more topologies described in connection with FIG. 5. In some examples, one or more of the readers 620 may be stationary readers. A stationary reader may be fixed at a certain location in the A-IoT system 605. For example, one or more of the readers 620 may be ceiling mounted readers. Additionally, or alternatively, one or more of the readers 620 may be mobile readers capable of moving to different locations in the A-IoT system 605. For example, one or more of the readers 620 may be handheld readers.

The network commander 610 may be configured to support the A-IoT system 605. The network commander 610 may be central control unit (e.g., a controller) configured to manage the A-IoT system 605. The network commander 610 may be a reader controller configured to manage, configure, and/or otherwise the readers 620 in the A-IoT system 605. For example, the network commander 610 may schedule and coordinate communications of all the readers 620 and/or collect data received (e.g., from one or more A-IoT devices 630) by the readers 620. In some examples, the network commander 610 may be, or may be included in, a network node 110. In some other examples, the network commander 610 may be, or may be included in, a UE 120. In some examples, the network commander 610 may be a separate network entity (e.g., a network node 110) from the readers 620 included in the A-IoT system 605. In some other examples, the network commander 610 may be, or may be included in, one of the readers 620 in the A-IoT system 605. In such examples, a network node 110 (e.g., a gNB may indicate a reader 620 that is to act as the network commander 610 to coordinate the other readers 620 and/or collect data from the other readers 620). In some examples, the network commander 610 may communicate with one or more of the readers 620 (e.g., one or more readers 620 that are network nodes 110) via a backhaul link. Additionally, or alternatively, the network commander 610 may communicate with one or more of the readers 620 (e.g., one or more readers 620 that are UEs 120) via a Uu interface (e.g., via downlink and/or uplink communications).

The A-IoT system 605 may include one or more A-IoT devices 630 (shown in FIG. 6 as A-IoT device 630-1 through A-IoT device 630-5 as an example). The readers 620 and the one or more A-IoT devices 630 may be physically dispersed throughout the A-IoT system 605. In some examples, the A-IoT devices 630 may be mobile devices or may be attached to moveable objects such that physical locations of the A-IoT devices 630 within the A-IoT system 605 may change over time. For example, an A-IoT device may be a tag attached to a physical object (e.g., for product or inventory tracking in a case in which the A-IoT system 605 is deployed in a store or warehouse).

In some examples, the readers 620 may operate in different modes to perform different actions for communicating with the one or more A-IoT devices 630 depending on scheduling decisions by the network commander 610. As shown in FIG. 6, a reader 620 may transmit an EH signal (e.g., an energizing signal) to provide energy to an A-IoT device 630. As shown by reference number 640, readers 620-1, 620-2, 620-3, and 620-4 may each transmit an EH signal, and A-IoT device 630-1 may harvest energy from the EH signals transmitted by readers 620-1, 620-2, 620-3, and 620-4. As shown by reference number 645, a reader 620 (e.g., reader 620-2) may transmit an R2D command to an A-IoT device 630 (e.g., A-IoT device 630-1). The R2D command may include one or more signals transmitted from a reader 620 to an A-IoT device 630 via a forward link. The R2D command may also be referred to as an R2D signal or an R2D message. As shown by reference number 650, a reader 620 (e.g., reader 620-4) may transmit a CW signal to an A-IoT device 630 (e.g., A-IoT device 630-1) via the forward link. The CW signal may be a continuous signal (e.g., a continuous wave signal). As shown by reference number 655, the A-IoT device 630 (e.g., A-IoT device 630-1) may transmit a D2R response to a reader 620 (e.g., reader 620-2). The D2R response may include one or more signals transmitted (e.g., reflected) from an A-IoT device 630 to a reader 620 via a backscatter link, such as the backscatter link 415 described in connection with FIG. 4. For example, an A-IoT device 630 (e.g., A-IoT device 630-1) may transmit the D2R response to a reader (e.g., reader 620-2) by reflecting a signal received via the forward link (e.g., the CW signal received from reader 620-4) as a backscatter signal in a similar manner as described elsewhere herein, such as in connection with FIG. 4. The D2R response may be, or may include, a response to the R2D command. The D2R response may also be referred to as a D2R signal or a D2R message.

In some examples, communications between the readers 620 and the A-IoT devices 630 in the A-IoT system 605 may occur over multiple steps. In such examples, communications between a reader 620 and an A-IoT device 630 may include multiple R2D signals (e.g., R2D commands) and multiple D2R signals (e.g., D2R responses). For example, a reader 620 and an A-IoT device 630 in the A-IoT system 605 may communicate using a multi-step approach similar to communications performed in an RFID system (e.g., an RFID inventory system). In such a multi-step approach, the reader 620 may send a query (e.g., via an R2D signal) to an A-IoT device 630 (e.g., a tag) in a first step. In a second step, the A-IoT device 630 (e.g., the tag) may respond (via a D2R signal) with a random number (e.g. a 16-bit number). In a third step, the reader 620 may send (e.g., via another R2D signal) an ACK including the number (e.g., the 16-bit number) received from the A-IoT device 630. In a fourth step, the A-IoT device 630 (e.g., the tag) may respond (e.g., via another D2R signal) with requested information associated with the A-IoT device 630, such as an electronic product code (EPC) associated with the A-IoT device 630 (e.g., the tag) or another identifier associated with the A-IoT device 630. In another example, communications between a reader 620 and an A-IoT device 630 may occur over multiple steps in a four step RACH procedure.

In an A-IoT deployment, such as the A-IoT system 605, deploying multiple readers 620 may be desirable to enhance the coverage of the A-IoT deployment and/or to provide positioning services for the A-IoT devices 630. For example, deploying multiple readers may enhance the coverage of the A-IoT deployment by enabling bi-static A-IoT communications and increasing a range of communications with the A-IoT devices 630 (e.g., due to a signal boost resulting from signals being transmitted from multiple readers 620). To maximize the performance gain from deploying multiple readers 620, the readers 620 should operate in a synchronized fashion so as not to cause interference with each other and also to enable load balancing. However, the readers 620 may have different capabilities (e.g., local clock accuracy, Tx power, and/or carrier frequency accuracy capabilities, among other examples) and/or include different categories of A-IoT reader devices, which are not considered by the network commander 610 when coordinating scheduling for the readers 620. As a result, performance gains from deploying multiple readers 620 may be limited.

As indicated above, FIG. 6 is provided as an example. Other examples may differ from what is described with respect to FIG. 6.

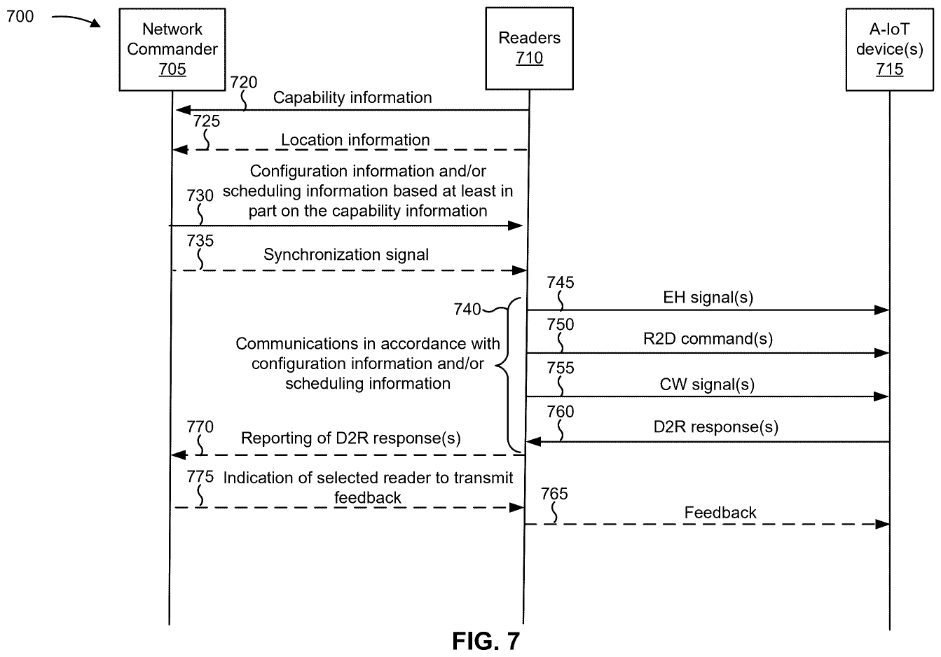

FIG. 7 is a diagram illustrating an example 700 associated with multi-reader A-IoT operation, in accordance with the present disclosure. As shown in FIG. 7, example 700 includes communication between a network commander 705, multiple readers 710, and one or more A-IoT devices 715. The network commander 705 may be a central control unit (e.g., a controller), a reader controller, the network commander 610, a network node 110, a UE 120, or another device. A reader 710 may be an A-IoT reader device, a reader 620, a network node 110, a UE 120, an intermediate node (e.g., the intermediate node 550), and/or an assisting node (e.g., the assisting node 560), among other examples. An A-IoT device 715 may be an A-IoT device 630, an EH-capable device, an A-IoT device 540, a UE 120, a RedCap UE, and/or a backscatter device (e.g., the backscatter device 405), among other examples. In some aspects, the network commander 705, the readers 710, and/or the A-IoT device(s) 715 may be part of a wireless network (e.g., the wireless communication network 100).

In some aspects, the readers 710 and the A-IoT device(s) 715 may be part of an A-IoT system (e.g., similar to the A-IoT system 605 discussed in connection with FIG. 6). The readers 710 may be included in a network of readers 710 deployed in the A-IoT system. The network commander 705 may be configured to configure, manage, schedule communications for, and/or otherwise control the readers 710. For example, the network commander 705 may be configured to allocate resources (e.g., time-frequency resources) to the readers 710 to be used for communications (e.g., collaborative communications) in the A-IoT system (e.g., with one or more A-IoT devices 715).

As shown in FIG. 7, and by reference number 720, the readers 710 may transmit, and the network commander 705 may receive, capability information associated with the readers 710. The capability information may be included in respective capability messages transmitted by the readers 710 and received by the network commander 705. For example, each reader 710 may transmit, to the network commander 705, a respective capability message (e.g., a respective capability report) indicating capability information associated with that reader 710. The network commander 705 may receive, from each reader 710, the respective capability message indicating the capability information associated with that reader 710. A reader 710 may transmit the capability message indicating the capability information associated with the reader 710 via an uplink communication, a sidelink communication, a backhaul communication, an Xn interface communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), and/or a physical sidelink shared channel (PSSCH), among other examples.

In some aspects, the capability information may indicate a respective reader category (e.g., a respective A-IoT reader category) for each reader 710. For example, the capability information associated each reader 710 may indicate the reader category (e.g., A-IoT reader category) for that reader 710. The reader category for a reader 710 may indicate a type device for the reader 710 and/or a functionality of the reader 710 for A-IoT communications (e.g., one or more types of A-IoT communications that the reader 710 is capable of performing). In some aspects, the reader category for a reader 710 may be one of a CW node, a transmit (Tx)-only node, or a fully-functional reader. In such examples, the respective reader category, for each reader 710, indicates that the reader 710 is a CW node, a Tx-only node, or a fully functional reader. A CW-only node is a reader 710 (e.g., a node) that can transmit a continuous signal (e.g., a CW signal) that can be used for providing energy to the A-IoT device(s) 715 or for backscattering. A CW-only node may not be used for (e.g., may not be capable of) transmitting R2D commands or receiving and decoding D2R responses. A Tx-only node is a reader 710 (e.g., a node) that can transmit downlink signals (or sidelink signals in a case in which the reader 710 is a UE) to the A-IoT device(s) 715. For example, a Tx-only node may be capable of transmitting a continuous signal (e.g., a CW signal) for providing energy to the A-IoT device(s) 715 and for backscattering, and transmitting downlink (or sidelink) commands (e.g., R2D commands) to the A-IoT device(s) 715. A Tx-only node may not be used for (e.g., may not be capable of) receiving and decoding D2R responses. A fully-functional reader is a reader 710 that can transmit downlink (or sidelink) signals (e.g., a continuous signal for providing energy to the A-IoT device(s) 715 and for backscattering, as well as R2D commands) and can receive and decode D2R responses from the A-IoT device(s) 715.

In some aspects, the capability information may indicate, for each reader 710, a local clock accuracy capability for the reader 710, a carrier frequency accuracy capability for the reader 710, and/or a Tx power capability for the reader 710. For example, the capability information may indicate the local clock accuracy capability, the carrier frequency accuracy capability, and/or the Tx power capability for each reader 710 in addition to or instead of the reader category for each reader 710. The local clock accuracy capability for a reader 710 may indicate a level at which the reader 710 can maintain a local clock accuracy over time. The carrier frequency accuracy capability for a reader 710 may indicate a level of accuracy that the reader 710 can maintain for a carrier frequency. The Tx power capability for a reader 710 may be a maximum Tx power for the reader 710.

In some aspects, the respective capability message transmitted by each reader 710 may be a detailed capability message include information elements (IEs) indicating the local clock accuracy capability, the carrier frequency accuracy capability, the transmit power capability, and/or the reader category, among other examples. In some other aspects, the respective capability message transmitted by each reader 710 may indicate a reader category, from a set of predefined reader categories, that is indicative one or more capability parameters (e.g., the local clock accuracy capability, the carrier frequency accuracy capability, and/or the transmit power capability, among other examples) for the reader 710. In such examples, each reader category, in the set of predefined reader categories, may correspond to a different combination of parameter values for the one or more capability parameters, and a reader 710 may indicate, in the capability message transmitted by the reader 710, an index associated with the reader category, from the set of predefined reader categories, that best matches the capability parameters for the reader 710.

As further shown in FIG. 7, and by reference number 725, in some aspects, one or more readers 710 may transmit, and the network commander 705 may receive, location information associated with the one or more readers 710. The location information may be indicative of respective locations of the one or more readers 710. In some aspects, the readers 710 (e.g., a plurality of readers in an A-IoT system) may include one or more stationary readers 710 located at fixed physical locations (e.g., ceiling mounted readers) and one or more mobile readers 710 capable of moving to different physical locations (e.g., handheld readers). In such examples, the network commander 705 may maintain of database of the locations of the one or more stationary readers 710 (e.g., the ceiling mounted readers), and the one or more mobile readers 710 (e.g., the handheld readers) may report their respective locations to the network commander 705. For example, each mobile reader 710 (e.g., handheld reader) of the plurality of readers 710 in the A-IoT system may transmit, and the network commander 705 may receive, respective location information indicative of the location of that mobile reader 710. In some aspects, a reader 710 may report the location of the reader 710 by reporting one or more neighboring readers 710 or access points. That is, the location information indicative of a location of a reader 710 may indicate one or more neighboring readers 710 or access points at a current location of the reader 710.

In some aspects, the locations of the readers 710 in the A-IoT system (e.g., the database of locations of one or more stationary readers 710 and/or the location information received from one or more mobile readers 710) may enable the network commander 705 to use the locations of the readers 710 as a reference grid to locate the A-IoT devices 715 in the A-IoT system. Additionally, or alternatively, the locations of the readers 710 may enable the network commander 705 to schedule simultaneous communications for different readers with reduce interference. Additionally, or alternatively, the locations of the readers 710 may enable the network commander 705 to configure groups of readers 710, based at least in part on the locations, to work together for cooperative communications with the A-IoT device(s) 715. For example, the locations of the readers 710 may enable the network commander 705 to schedule different readers 710 (e.g., within a group of readers 710 or in different groups of readers 710) to transmit simultaneously.

As further shown in FIG. 7, and by reference number 730, the network commander 705 may transmit, and the readers 710 may receive, configuration information and/or scheduling information based at least in part on the capability information. In some aspects, the network commander 705 may transmit the configuration information and/or the scheduling information via one or more of system information signaling (e.g., a master information block (MIB) and/or a system information block (SIB), among other examples), RRC signaling, MAC signaling (e.g., one or more MAC-CEs), DCI, and/or signaling via a backhaul link, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples. In some aspects, the subsequent indication may be included in subsequent configuration information transmitted by the network commander 705. In some other aspects, the subsequent indication may be included in the scheduling information.

In some aspects, the configuration may indicate a synchronization signal configuration associated with a periodic synchronization signal for time and frequency synchronization of the readers 710. In some examples, the configuration information may indicate a same synchronization signal configuration for different readers 710 (e.g., for all or a portion of the readers 710). In some other examples, the configuration information may indicate different synchronization signal configurations for different readers 710. For example, first configuration information transmitted to a first reader 710 may indicate a first synchronization signal configuration, and second configuration information transmitted to a second reader 710 may indicate a second synchronization signal configuration. In some aspects, the synchronization signal configuration for one or more readers 710 may be based at least in part the capability information for the one or more readers 710. For example, one or more readers 710 with high local frequency jitter may be configured to perform synchronization based on a periodic synchronization signal transmitted by the network commander 705 so that the one or more readers 710 can maintain a certain clock error. In such examples, the periodicity of the synchronization signal configured for the one or more readers 710 may be based at least in part on the local clock accuracy capabilities and/or the carrier frequency accuracy capabilities of the one or more readers 710. In some aspects, the synchronization signal configuration may indicate time and frequency resources for the synchronization signal and/or a periodicity of the synchronization signal, among other examples. In some examples, the synchronization signal configuration may configured the time and frequency resource for the synchronization signal via higher layer (e.g., RRC) signaling, and the configured time and frequency resources for the synchronization signal may be update via MAC-CE. In some aspects, the configuration information may configure one or more of the readers 710 to use a backhaul connection with the network commander 705 (e.g., a backhaul link) for time and frequency synchronization.

In some aspects, the configuration information or the scheduling information may configure one or more groups of readers 710. Each group of readers 710 may include multiple readers 710. The network commander 705 may configure a group of readers 710 to work together for communicate with one or more A-IoT devices 715. That is, the network commander 705 may transmit, to the readers 710 in a group of readers 710, configuration information and/or the scheduling information indicating that the readers 710 are configured to be in the group. In some aspects, multiple groups of readers 710 may be configured via the configuration information and/or the scheduling information. In some examples, groups of readers 710 may be non-overlapping. That is, the groups of readers 710 configured via the configuration information and/or the scheduling information may include multiple non-overlapping groups of readers 710. A first group of readers 710 and a second group of readers 710 are non-overlapping if there is no reader 710 that is included in both the first group of readers 710 and the second group of readers 710. In some other examples, groups of readers 710 may be overlapping. That is, the groups of readers 710 configured via the configuration information and/or the scheduling information may include a first group of readers 710 and a second group readers 710 that overlaps with the first group of readers 710. A first group of readers 710 and a second group of readers 710 overlap if there is at least reader 710 that is included in both the first group of readers 710 and the second group of readers 710.

In some aspects, the network commander 705 may configure each reader 710 in a group of readers 710 with a group membership. For example, the network commander 705 may transmit, to each reader 710 included in a group of readers 710, at an indication (e.g., in the configuration information or the scheduling information) that the reader 710 is included the group of readers 710. In some examples, the indication that the reader 710 is included the group of readers 710 may be a dynamic indication transmitted by the network commander 705 and received by the reader 710. In some other examples, the indication that the reader 710 is included the group of readers 710 may be included in a static configuration transmitted by the network commander 705 and received by the reader 710. In some aspects, the network commander 705 may transmit, to a reader 710, a static configuration (e.g., in the configuration information) indicating multiple candidate groups configured for the reader 710, and the network commander 705 may transmit, to the reader 710 a dynamic indication (e.g., in the scheduling information or in subsequent configuration information) indicating a group of the multiple candidate groups configured for the reader 710. In some aspects, the network commander 705 may transmit, to a reader 710, an indication (e.g., in the configuration information or the scheduling information) that the reader 710 is included in multiple groups of readers 710 (e.g., multiple overlapping groups of readers 710).

In some aspects, the groups of readers 710 configured via the configuration information and/or the scheduling information may be based at least in part on the capability information associated with the readers 710 and based at least in part on respective locations of the readers 710. For example, the network commander 705 may determine the groups of readers 710 to work together for cooperative communication with one or mor A-IoT devices 715 based at least in part on the capability information associated with the readers 710 and based at least in part on the locations of the readers 710. In some examples, the locations of one or more readers 710 (e.g., one or more mobile readers 710) may be indicated in location information received transmitted by the one or more readers 710 and received by the network commander 705. Additionally, or alternatively, the network commander 705 may maintain a database of locations of one or more readers 710 (e.g., one or more stationary readers 710).

In some aspects, the configuration information and/or the scheduling information may configure, for a group of readers 710, a cooperative communication scheme (or a cooperative transmission scheme) to be used by the readers 710 in the group of readers 710. The configuration information and/or the scheduling information may configure a respective cooperative communication scheme for each group of readers 710 configured via the configuration information and/or the scheduling information. The cooperative communication scheme for a group of readers 710 configures one or more respective actions for each reader 710 in the group of readers 710 in a communication time window associated with the group of readers 710. That is, the cooperative communication scheme for a group of readers 710 configures each reader 710 in the group of reader 710 to perform one or more actions during the communication time window associated with the group of readers 710. The communication time window may be a time duration (e.g., a set of time resources) in which a set of A-IoT communications are performed by the readers 710 in the group of readers 710. In some aspects, the cooperative communication scheme for a group of readers 710 may configure each reader 710 in the group to perform one or more of the following actions in the communication time window associated with the group: transmitting an EH signal (e.g., a wireless power transfer (WPT) signal); transmitting an R2D command (e.g., a query command); transmitting a CW signal for backscattering; monitoring (e.g., listening) for a D2R response (e.g., a response from an A-IoT device 715) to the R2D command; remaining inactive (e.g., keeping silent) during at least a portion of the communication time window; or communicating (e.g., exchanging information) with the network commander 705.

In some aspects, the cooperative communication scheme for a group of readers 710 may be based at least in part on the capability information associated with the readers 710 in the group. In some examples, the cooperative communication scheme may configure actions for a reader 710 in a group based at least in part on the reader category for the reader 710. For example, the cooperative communication scheme may configure a reader 710 that is a CW node to transmit an EH signal and/or transmit a CW signal for backscattering during the communication time window. In some examples the cooperative communication scheme may configure actions for a reader 710 in a group based at least in part on the local clock accuracy capability and/or the carrier frequency accuracy capability of the reader 710. For example, readers 710 with low clock accuracy may not be able to ensure alignment of the phase of signals transmitted by the readers 710, which can cause destructive interference and degrade the performance of the A-IoT communications. Accordingly, such readers 710 may be configured to perform EH transmission, but not other communications, in the communication time window because the synchronization of EH signals may be relaxed as compared with simultaneous transmissions of other A-IoT communications.

In some examples, the cooperative communication scheme for a group of readers 710 may be static for one or more of the readers 710 in the group. In such examples, one or more of the readers 710 in the group may be configured to perform the same one or more actions (e.g., transmit the same signal) in each communication time window (e.g., each transmission round) associated with the group of readers 710. In some other examples, the cooperative communication scheme for a group of readers 710 may be dynamic. In such examples, one or more of the readers 710 in the group may be configured to perform different actions (e.g., transmit and/or receive different signals) in different communication time windows (e.g., different transmission rounds) associated with the group of readers 710. For example, the cooperative communication scheme may configure a “round robin” communication scheme, in the readers 710 in the group cycle through the different actions (e.g., transmission and/or reception of different signals) in different communication time windows.

In some aspects, the cooperative communication scheme may be configured for a group of readers 710 via respective transmissions of configuration information and/or scheduling information from the network commander 705 to each reader 710 in the group. For example, the network commander 705 may transmit, to each reader 710 in the group of readers 710, respective configuration information or scheduling information that configures/schedules the one or more actions (e.g., EH signal transmission, R2D command transmission, CW signal transmission, and/or D2R monitoring/reception, among other examples) to be performed by that reader 710 in the communication time window associated with the group.

In some aspects, the cooperative communication scheme for a group of readers 710 may configure one or more readers 710 in the group to perform EH signal transmission, one or more readers 710 in the group to perform R2D transmission, one or more readers 710 in the group to perform CW signal transmission for backscattering, and one or more readers 710 in the group to perform D2R reception/monitoring in the communication time window associated with the group of readers 710. In some aspects, the cooperative communication scheme may configure all of the readers 710 in a group of readers 710 to perform EH signal transmission, for providing energy to one or more A-IoT devices 715, in the communication time window associated with the group of readers 710. Energizing the one or more A-IoT devices 715 may cause a bottleneck for communications with the A-IoT device(s) 715 in an A-IoT system. In some examples, configuring all of the readers 710 in the group of readers 710 to perform EH signal transmission may reduce the time required for energizing the A-IoT device(s) 715, resulting in improved latency for communicating with the A-IoT device(s) 715 in the A-IoT system. In some aspects, the different readers 710 in the group of readers 710 may use different tones for transmitting the EH signal in the communication time window associated with the group. In such examples, the configuration information or the scheduling information may indicate different tones to be used for respective EH signal transmissions by the different readers 710 in the group. In some aspects, the different readers 710 in the group of readers 710 may use different carrier frequencies for transmitting the EH signal in the communication time window associated with the group. In such examples, the configuration information or the scheduling information may indicate different carrier frequencies to be used for respective EH signal transmissions by the different readers 710 in the group. In some examples, the carrier frequencies used by the readers 710 in the group for the EH signal transmissions may be dependent on time domain resources in which the EH signal transmissions are scheduled. For example, frequency hopping may be configured for the EH signal transmissions.

In some aspects, the cooperative communication scheme for a group of readers 710 may configure one or more of the readers 710 in the group to perform R2D command transmission in the communication time window associated with the group. In some examples, the one or more readers 710 configured to perform R2D command transmission may not include all of the readers 710 in the group. For example, because a wakeup receiver sensitivity of an A-IoT device 715 is likely to be higher than an energy harvesting sensitivity of the A-IoT device 715, fewer readers 710 in the group may be configured to perform R2D command transmission as compared with EH signal transmission. Furthermore, a high level of time synchronization may be associated with simultaneous transmission of the R2D command as an A-IoT device 715 may rely on on-off keying (OOK) detection and small time offsets between the readers 710 can destroy the signal at the A-IoT device 715. In some aspects, in a case in which multiple readers 710 in the group are configured to transmit the R2D command in the communication time window associated with the group, a high frequency shift may be injected between the readers 710 transmitting the R2D command so that the envelope of the received signal at the A-IoT device 715 is not slowly modulated by the frequency offset between the readers 710. In such examples, the cooperative communication scheme may configure a frequency shift (e.g., the high frequency shift) between a transmission of the R2D command by a first reader 710 in the group and a transmission of the R2D command by a second reader 710 in the group.

In some aspects, the cooperative communication scheme for a group of readers 710 may configure one or more of the readers 710 in the group (e.g., one or more first readers 710 in the group) to perform CW signal transmission time window associated with the group, and one or more other readers 710 in the group (e.g., one or more second readers 710, different from the one or more first readers 710, in the group) to perform reception of (e.g., monitoring/listening for) a backscattered D2R signal (e.g., a D2R response) in the communication time window associated with the group. The one or more readers 710 configured to perform CW transmission (e.g., the one or more first readers 710) may be configured/scheduled to perform CW transmission in a same set of time resources in the communication time window as the one or more other readers 710 (e.g., the one or more second readers 710) are configured/scheduled to perform reception of (e.g., monitoring/listening for) the backscattered D2R signal. In some examples, the A-IoT devices 715 may include one or more passive A-IoT devices 715 that rely on backscattering. In such examples, some (e.g., one or more) of the readers 710 in the group may be configured to transmit CW signals for backscattering, while the remaining readers 710 in the group (or a subset of the remaining readers 710 in the group) may be configured to listen to (e.g., receive) the backscattered signal (e.g., the D2R response) transmitted by the A-IoT device(s) 715. In some aspects, with the help of directional antennas, the interference of the CW transmitter reader(s) 710 in the group at a stationary reader 710 (e.g., a ceiling mounted reader) in the group that receives the D2R response can be reduced or minimized.

In some aspects, the cooperative communication scheme for a group of readers 710 may configure full cooperation between the readers 710 in the group for at least a portion of the communication time window associated with the group. In this case, all of the readers 710 in the group may be configured to be doing the same activity (e.g., performing the same action) at the same time. For example, the cooperative communication scheme may configure full cooperation between all of the readers 710 in a group for transmitting the EH signal. In some aspects, the cooperative communication scheme for a group of readers 710 may configure a full split between the readers 710 in the group for at least a portion of the communication time window associated with the group. In this case, all of the readers 710 in the group may be active at the same time, but a subset of the readers 710 in the group may be configured to be doing a different task (e.g., performing a different action) from the other readers 710 in the group. For example, the cooperative communication scheme may configure a full split for CW transmission and D2R response reception in the communication tome window associated with the group. In some aspects, the cooperative communication scheme for a group of readers 710 may configure load balancing for the readers 710 in the group for at least a portion of the communication time window associated with the group. In this case, some (e.g., one or more) of the readers 710 in the group are configured to be inactive while the other readers 710 in the group are active. In some examples, the cooperative communication scheme may configure a “round robin” scheme, in which different readers 710 are configured to be inactive in different communication time windows associated with the group, to ensure good load balancing between the readers 710 in the group.

In some aspects, the scheduling information may schedule the communication time windows associated with the groups of readers 710. In some aspects, in a case in which multiple groups of readers 710 are configured, time domain multiplex (TDM) operation between different groups of readers 710 may be implemented to in order to minimize/reduce the interference from one group of readers 710 to another group of readers 710. In such examples, the respective time domain windows associated with different groups of readers 710 may be time domain multiplexed such that the operation times (e.g., the respective time domain windows) for the different groups are scheduled in different time domain resources. For example, in a case in which a first group of readers 710 and a second group of readers 710 are configured, the scheduling information may schedule a first communication time window associated with the first group of readers 710 and a second communication time window associated with the second group of readers 710 such that the first communication time window is time division multiplexed with the second communication time window. In some aspects, the time domain multiplexing of the communication time windows associated with the different groups of readers 710 may be based at least in part on the locations of the readers 710 in the groups of readers 710. For example, the communication time windows of neighboring or overlapping groups of readers 710 may be time division multiplexed.

As further shown in FIG. 7, and by reference number 735, in some aspects, the network commander 705 may transmit a synchronization signal. In some aspects, the network commander 705 may transmit a periodic synchronization signal in accordance with a synchronization signal configuration indicated in the configuration information. For example, the periodic synchronization signal may be configured for time and frequency synchronization of one or more readers 710 (e.g., all or a portion of the readers 710). In some aspects, one or more of the readers 710 may receive the synchronization signal (e.g., the periodic synchronization signal) in accordance with the synchronization signal configuration indicated in the configuration information, and the one or more readers 710 may perform time and frequency synchronization based at least in part on the synchronization signal (e.g., the periodic synchronization signal). In some aspects, one or more readers 710 may perform time and frequency synchronization using a backhaul connection with the network commander 705.

As further shown in FIG. 7, and by reference number 740, the readers 710 may perform communications with the one or more A-IoT devices 715 in accordance with the configuration information and/or the scheduling information. In some aspects, each group of readers 710 configured via the configuration information and/or the scheduling information may perform communications with the one or more A-IoT devices 715, in one or more scheduled communication time windows associated with that group of readers 710, in accordance with the cooperative communication scheme configured for that group of readers 710. Each reader 710 in a group of readers 710 may perform the one or more actions configured for that reader 710 in the communication time window associated with the group of readers 710, in accordance with the cooperative communication scheme for the group of readers 710 (e.g., in accordance with the one or more actions configured for the reader 710 in the configuration information and/or scheduling information received by the reader 710).

As shown by reference number 745, one or more readers 710 in a group of readers 710 may transmit EH signals in the communication time window associated with the group of readers 710, in accordance with the cooperative communication scheme configured for the group of readers 710. The one or more readers 710 may transmit the EH signals to one or more A-IoT devices 715 to provide energy for the A-IoT device(s) 715. In the A-IoT device(s) 715 may perform energy harvesting using the EH signals transmitted by the one or more readers 710. In some aspects, all of the readers 710 in the group of readers 710 may transmit EH signals in the communication time window associated with the group. In some aspects, different readers 710 in the group of readers 710 may transmit the EH signals using different tones and/or different carrier frequencies. In such examples, the different tones and/or the different frequencies used by the different readers 710 may be indicated in the configuration information or the scheduling information.

As shown by reference number 750, one or more readers 710 in a group of readers 710 may transmit an R2D command to an A-IoT device 715 in the communication time window associated with the group of readers 710, in accordance with the cooperative communication scheme configured for the group of readers 710. The A-IoT device 715 may receive the R2D command. In some aspects, in a case in which a first reader 710 in the group and a second reader 710 in the group both transmit the R2D command to the A-IoT device 715, a frequency shift may be applied between the transmission of the R2D command by the first reader 710 and the transmission of the R2D command by the second reader 710. For example, the frequency shift may be indicated in the configuration information or the scheduling information.

As shown by reference number 755, one or more readers 710 in a group of readers 710 may transmit CW signals to an A-IoT device 715 in the communication time window associated with the group of readers 710, in accordance with the cooperative communication scheme configured for the group of readers 710. As shown by reference number 760, one or more readers 710 in the group of readers 710 may receive a D2R response from the A-IoT device 715 in the communication time window associated with the group of readers 710, in accordance with the cooperative communication scheme configured for the group of readers 710. In some aspects, one or more first readers 710 in the group of readers 710 may transmit the CW signals, and one or more second readers 710, other than the first readers 710, in the group of readers 710 may receive the D2R response. The one or more first readers 710 may transmit the CW signals, and the second one or more readers 710 may receive (e.g., monitor for) the D2R response, in a same set of time resources in the communication time window. The A-IoT device 715 may receive the CW signal(s) transmitted by the one or more first readers 710, and the A-IoT device 715 may transmit the D2R response by backscattering the CW signal(s). The D2R response may be a backscattered D2R signal resulting from the backscattering the CW signal(s).

As further shown in FIG. 7, and by reference number 765, in some aspects, at least one reader 710 that receives a D2R response from an A-IoT device 715 may transmit, to the A-IoT device 715, feedback (e.g., an ACK message) associated with the D2R response. The A-IoT device 715 may receive the feedback associated with the D2R response. For example, at least one reader 710 that receives the D2R response from the A-IoT device 715 may transmit in a case of a multi-step communication procedure, such as an RFID query procedure, an A-IoT multi-step communication procedure similar to the RFID query procedure, or four-step RACH procedure, among other examples. In this case, the feedback may a communication associated with a step of the multi-step communication procedure. However, in some cases multiple readers 710 (e.g., multiple readers 710 in a group of readers 710) may receive an R2D response transmitted by an A-IoT device 715, and in such cases, confusion as to which reader 710 is to respond to the A-IoT device 715 with the feedback may cause scheduling issues.

In some aspects, as shown by reference number 770, readers 710 that receive an R2D response may report the R2D response to the network commander 705. Each reader 710 that receives an R2D response from an A-IoT device 715 may transmit, to the network commander 705, an indication associated with the D2R response received from the A-IoT. The network commander 705 may receive the indication associated with the D2R response transmitted by each reader 710. In a case in which multiple readers 710 receive a D2R response from an A-IoT device 715, the network commander 705 may receive, from the multiple readers 710 that received the D2R response, respective indications associated with the D2R response received by the multiple readers 710. In some aspects, the respective indications associated with the D2R response may include respective RSSI measurements for the D2R response. That is, each reader 710 that receives the D2R response may include an RSSI measurement for the D2R response in the indication associated with the D2R response that is transmitted to the network commander 705. The network commander 705 may select a reader 710 to transmit the feedback associated with the D2R response. For example, the network commander 705 may select a reader 710, from the multiple readers 710 that received the D2R response, to transmit the feedback associated with the D2R response to the A-IoT device 715. In some examples, the network commander 705 may select the reader 710 to transmit the feedback associated with the D2R response based at least in part on the RSSI measurements for the D2R response. For example, the network commander 705 may select the reader 710 with the strongest (e.g., highest) RSSI measurement for the D2R response. As shown by reference number 775, the network commander 705 may transmit an indication of the selected reader 710 to transmit the feedback associated with the D2R response. In some examples, the network commander 705 may transmit, to each reader 710 that reported the D2R response to the network commander 705, an indication of whether that reader 710 is to transmit the feedback. In this case, the network commander 705 may transmit, to the selected reader 710, an indication to transmit the feedback associated with the D2R response. The selected reader 710 may then transmit the feedback to the A-IoT device 715 in connection with receiving the indication to transmit the feedback.

In some other aspects, a reader 710 that receives a D2R response from an A-IoT device 715 may determine whether to transmit feedback associated with the D2R response to the A-IoT device 715 based at least in part on an RSSI threshold. In such examples, each reader 710 that receives a D2R response may determine whether to transmit feedback associated with the D2R response without reporting the D2R response to the network commander 705 (and without receiving an indication of whether to transmit the feedback from the network commander 705). The RSSI threshold may be indicated in the configuration information. A reader 710 that receives a D2R response from an A-IoT device 715 may measure the RSSI of the D2R response. The reader 710 may transmit the feedback associated with the D2R response to the A-IoT device 715 in connection with the RSSI measurement for the D2R response satisfying the RSSI threshold. The reader 710 may not transmit (e.g., refrain from transmitting) the feedback associated with the D2R response in connection with the RSSI measurement for the D2R response not satisfying the RSSI threshold. This may reduce control signaling overhead as compared with reporting D2R responses to the network commander 705 and receiving an indication of a selected reader 710 to transmit the feedback for each D2R response.

In some other aspects, the configuration information may indicate an RSSI threshold, and a reader 710 that receives a D2R response from an A-IoT device 715 may measure the RSSI of the D2R response and determine whether the RSSI measurement satisfies the RSSI threshold. The reader 710 may transmit the feedback associated with the D2R response to the A-IoT device 715 in connection with the RSSI measurement for the D2R response satisfying the RSSI threshold. In addition, the readers 710 may periodically report, to the network commander 705, D2Rs received by the readers 710 with RSSI measurements that fail to satisfy the RSSI threshold. For example, the network commander 705 may receive, from one or more readers 710, periodic reporting indicating one or more D2R responses with RSSI measurements that do not satisfy the RSSI threshold. The network commander 705 may select a reader 710 to transmit the feedback for each reported D2R response that failed to satisfy the RSSI threshold at any reader 710. The network commander 705 may transmit an indication of the selected reader 710 to transmit the feedback for each D2R response that failed to satisfy the RSSI threshold at any reader 710. For example, the network commander 705 may transmit, to each of the one or more readers 710 that reported a D2R response that failed to satisfy the RSSI threshold, an indication of whether that reader 710 is to transmit the feedback for the D2R response. In this case, the network commander 705 may transmit, to the selected reader 710 for a D2R response that failed to satisfy the RSSI threshold, the selected reader 710 is to transmit the feedback associated with the D2R response. The selected reader 710 may then transmit the feedback associated the D2R response in connection with receiving the indication to transmit the feedback associated with the D2R response. This may reduce control signaling overhead as compared with reporting all D2R responses to the network commander 705 and receiving an indication of a selected reader 710 to transmit the feedback for each D2R response, and may reduce instances in which A-IoT devices 715 do not receive feedback (e.g., for D2R responses with weak RSSI measurements) as compared with only using the RSSI threshold to determine whether to transmit the feedback.

As indicated above, FIG. 7 is provided as an example. Other examples may differ from what is described with respect to FIG. 7.

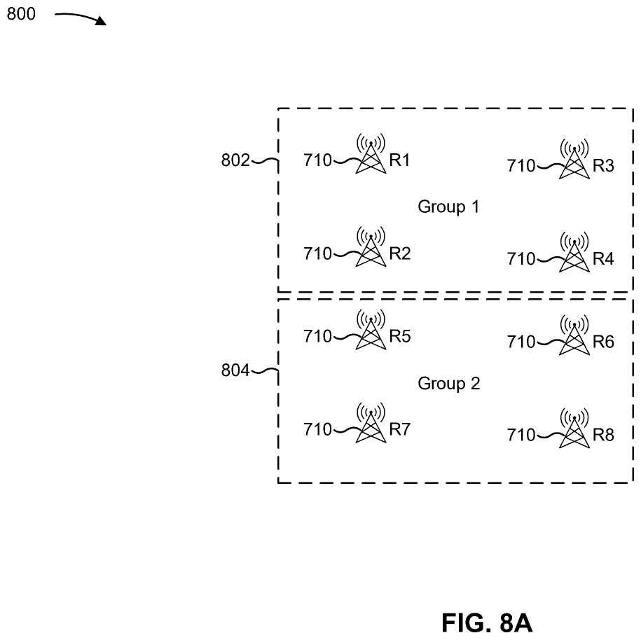

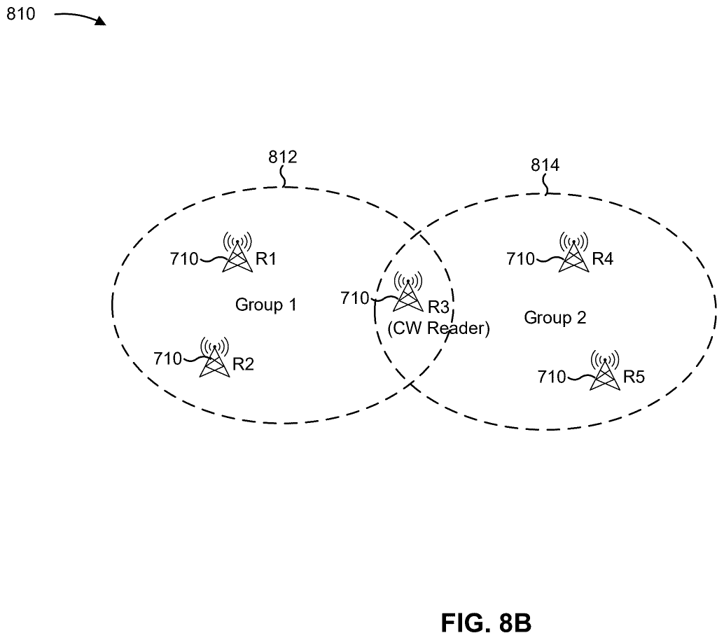

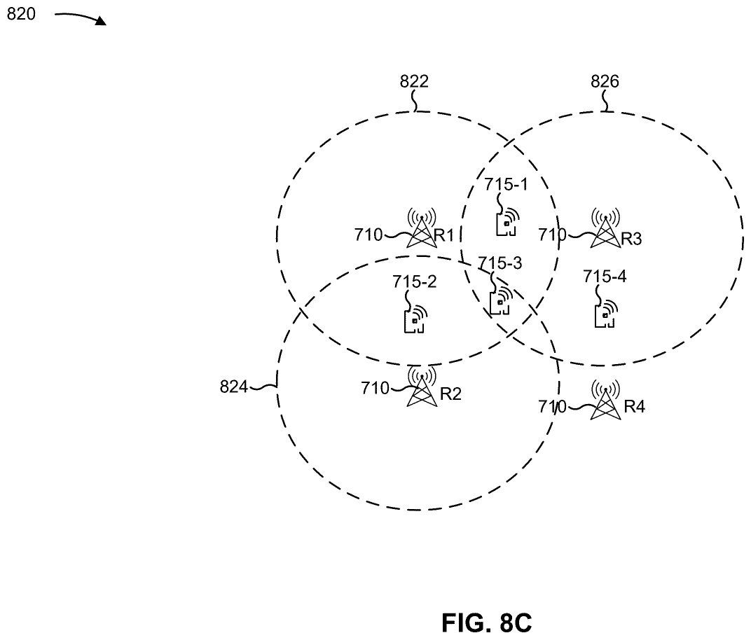

FIGS. 8A-8C are diagrams illustrating examples associated with grouping of readers for multi-reader A-IoT operation, in accordance with the present disclosure.

FIG. 8A shows an example 800 of non-overlapping groups of readers 710. As shown in FIG. 8A, example 800 includes a first reader (R1) 710, a second reader (R2) 710, a third reader (R3) 710, a fourth reader (R4) 710, a fifth reader (R5) 710, a sixth reader (R6) 710, a seventh reader (R7) 710, and an eighth reader (R8) 710. The readers 710 are grouped into a first group (Group 1) 802 and a second group (Group 2) 804. The first group 802 includes R1 710, R2 710, R3 710, and R4 710. The second group 804 includes R5 710, R6 710, R7 710, and R8 710. As shown in FIG. 8A, the first group 802 and the second group 804 do not overlap (e.g., there is no reader 710 included in both the first group 802 and the second group 804).

FIG. 8B shows an example 810 of overlapping groups of readers 710. As shown in FIG. 8B, example 810 includes a first reader (R1) 710, a second reader (R2) 710, a third reader (R3) 710, a fourth reader (R4) 710, and a fifth reader (R5) 710. The readers 710 are grouped into a first group (Group 1) 812 and a second group (Group 2) 814. The first group 812 includes R1 710, R2 710, and R3 710, and the second group 814 includes R3 710, R4 710, and R5 710. The first group 812 and the second group 814 share R3 710. As shown in FIG. 8B, R3 710 may be a CW reader. In some aspects, a CW reader (e.g., R3 710) may be shared between two groups of readers 710 (e.g., the first group 812 and the second group 814). In such examples, by aligning the transmission times of the two groups (e.g., the first group 812 and the second group 814), the CW reader (e.g., R3 710) may transmit CW signals for backscattering by A-IoT devices both groups while the other readers 710 in each group can receive D2R signals resulting from the A-IoT devices backscattering the CW signals. For example, the scheduling information may schedule CW signal transmission by R3 710 in one or more time resources, the scheduling information may schedule D2R signal reception by R1 710 and/or R2 710 in the one or more time resources, and the scheduling information may schedule D2R reception by R4 710 and/or R5 710 in the one or more time resources.

FIG. 8C shows an example 820 of coverage enhancement due to cooperative CW signal transmission in a group of readers 710. Example 820 includes a group of readers 710 including a first reader (R1) 710, a second reader (R2) 710, a third reader (R3) 710, and a fourth reader (R4) 710. Example 820 also includes A-IoT devices 715-1, 715-2, 715-3, and 715-4. In example 820, R1 710, R2 710, and R3 710 are configured to simultaneously transmit CW signals (e.g., in accordance with a cooperative communication scheme associated with the group of readers 710). Coverage areas for the CW signals transmitted by R1 710, R2 710, and R3 710 are shown by reference numbers 822, 824, and 826, respectively. As shown in FIG. 8C, the simultaneous CW signal transmissions by R1 710, R2 710, and R3 710 provide a signal boost to different A-IoT devices 715 depending on the locations of the A-IoT devices 715 with respect to the transmitting readers 710. For example, there may be a 3 dB signal boost at A-IoT device 715-1, a 3 dB signal boost at A-IoT device 715-2, a 4.77 dB signal boost at A-IoT device 715-3, and no signal boost at A-IoT device 715-4. Such signal boosts at A-IoT devices 715-1, 715-2, and 715-3 may provide increased signal strength for backscattered signals resulting from backscattering the CW signals and/or an increased coverage range for communicating with A-IoT devices 715-1, 715-2, and 715-3. In some aspects, a “round robin” scheme for switching between the different roles of the readers 710 within the group (e.g., different actions performed by the readers 710 within the group) may be used to increase fairness of coverage between different A-IoT devices 715.

As indicated above, FIGS. 8A-8C are provided as examples. Other examples may differ from what is described with respect to FIGS. 8A-8C.

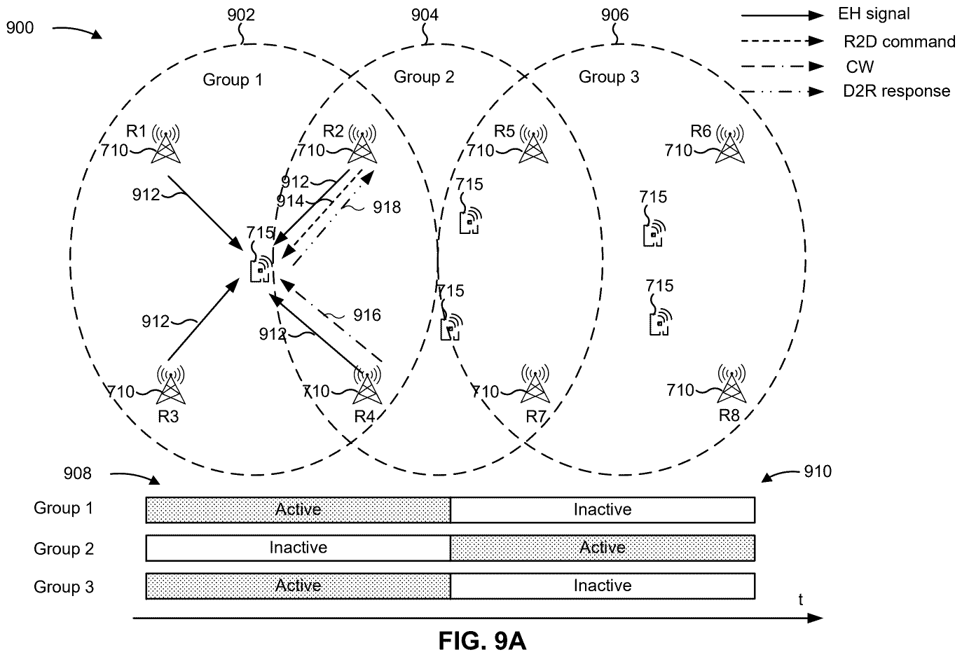

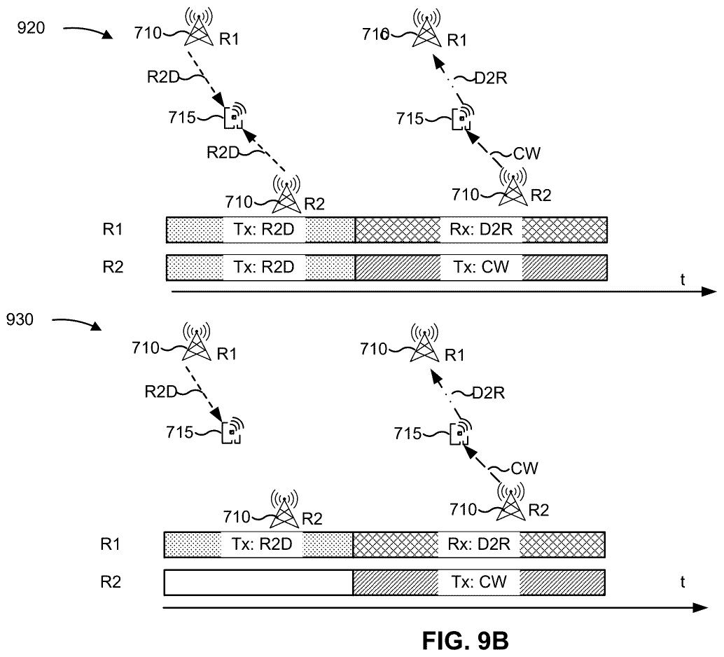

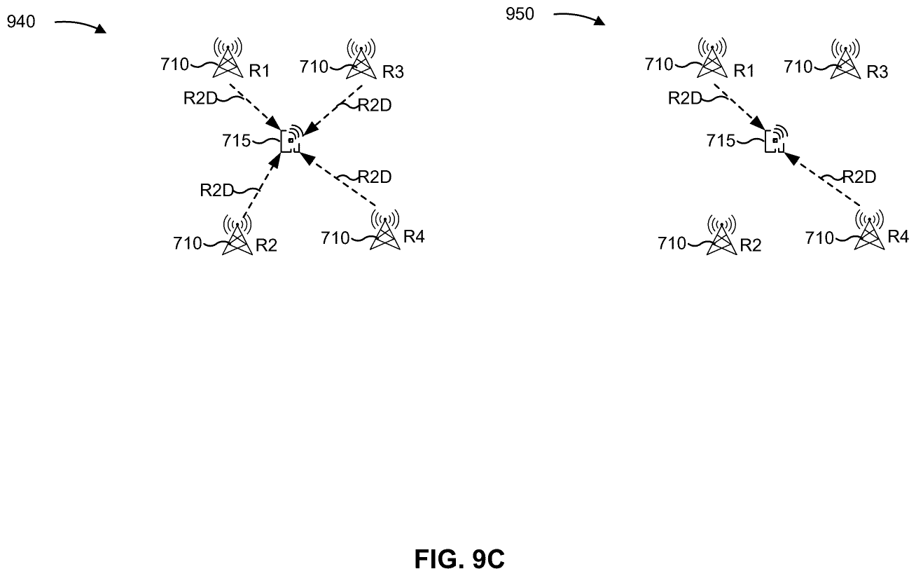

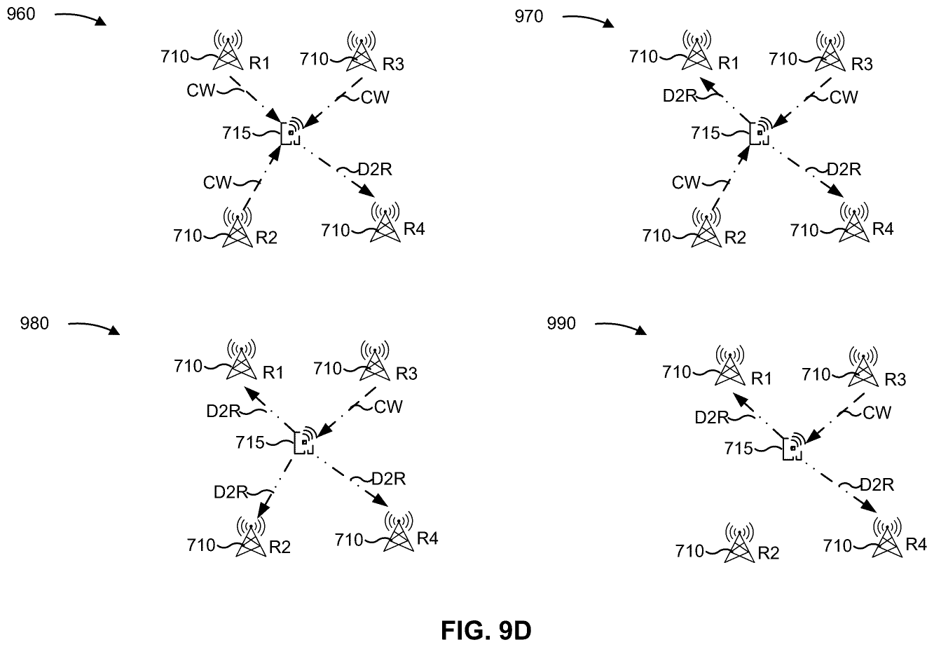

FIGS. 9A-9D are diagrams illustrating examples associated with cooperative communication schemes for multi-reader A-IoT operation, in accordance with the present disclosure.

FIG. 9A shows an example 900 of TDM operation between different groups of readers 710. Example 900 includes a first reader (R1) 710, a second reader (R2) 710, a third reader (R3) 710, a fourth reader (R4) 710, a fifth reader (R5) 710, a sixth reader (R6) 710, a seventh reader (R7) 710, and an eighth reader (R8) 710. The readers 710 are grouped into a first group (Group 1) 902, a second group (Group 2) 904, and a third group (Group 3) 906. The first group 902 includes R1 710, R2 710, R3 710, and R4 710, the second group 904 includes R2 710, R4 710, R5 710, and R7 710, and the third group 906 includes R5 710, R6 710, R7 710, and R8 710. In some aspects, to minimize interference between the groups 902, 904, and 906, the operation time may be split between the three groups 902, 904, 906. As shown by reference number 908, the first group 902 and the third group 906 may be active for a first time duration (e.g., for a first set of time resources), and the second group 904 may inactive for the first time duration (e.g., for the first set of time resources). As shown by reference number 910, the second group 904 may be active for a second time duration (e.g., for a second set of time resources), and the first group 902 and the third group 906 may be inactive for the second time duration (e.g., for the second set of time resources). In example 900, the first group 902 and the third group 906 are activated at the same time (e.g., the communication time windows associated with the first group 902 and the third group 906 are scheduled at the same time), and the second group 904 is activated at different time from the first group 902 and the third group 906. For example, the communication time window associated with the second group 904 is time division multiplexed with the communication time windows associated with the first group 902 and the third group 906.

As further shown in FIG. 9A, during the operation time in which a group of readers 710 is active (e.g., during the communication time window associated with the group), one or more readers 710 in the group may perform communications in accordance with a cooperative communication scheme associated with the group. For example, as shown by reference number 912, during the operation time in which the first group 902 is active, one or more readers 710 in the first group 902 (e.g., R1, R2, R3, and R4 in example 900) may transmit EH signals to provide energy to an A-IoT device 715. As shown by reference number 914, during the operation time in which the first group 902 is active, one or more readers 710 in the first group 902 (e.g., R2 in example 900) may transmit an R2D command to an A-IoT device 715. As shown by reference number 916, during the operation time in which the first group 902 is active, one or more readers 710 in the first group 902 (e.g., R4 in example 900) may transmit a CW signal to an A-IoT device 715. As shown by reference number 918, during the operation time in which the first group 902 is active, one or more readers 710 in the first group 902 (e.g., R2 in example 900) may receive a D2R response from an A-IoT device 715.

FIG. 9B shows examples 920 and 930 of cooperative communication schemes for a group of two readers (shown as R1 710 and R2 710). In example 920, both R1 710 and R2 710 transmit an R2D signal (e.g., an R2D command) to an A-IoT device 715 in a first portion of a communication time window associated with the group. That is, cooperative transmission of the R2D signal is configured in example 920. In example 920, R2 710 transmits a CW signal to the A-IoT device 715 in a second portion of the communication time window associated with the group, and R1 710 receives a D2R signal (e.g., a D2R response) from the A-IoT device 715 in the second portion of the communication time window associated with the group.

In example 930, R1 710 transmits an R2D signal (e.g., an R2D command) to an A-IoT device 715 in a first portion of a communication time window associated with the group, while R2 710 is inactive (e.g., R2 710 remains silent) during the first portion of the communication time window associated with the group. That is, single reader transmission of the R2D signal is configured in example 930. In example 930, R2 710 transmits a CW signal to the A-IoT device 715 in a second portion of the communication time window associated with the group, and R1 710 receives a D2R signal (e.g., a D2R response) from the A-IoT device 715 in the second portion of the communication time window associated with the group.

FIG. 9C shows examples 940 and 950 of R2D communications in cooperative communication schemes for a group of four readers (shown as R1 710, R2 710, R3 710, and R4 710). As shown in example 940, all readers 710 (e.g., R1, R2, R3, and R4) may transmit an R2D signal (e.g., an R2D command) to the A-IoT device 715 in a communication time window associated with the group. As shown in example 950, only a subgroup of readers 710 may transmit an R2D signal (e.g., an R2D command) to an A-IoT device 715 in a communication time window associated with the group. For example, R1 710 and R2 710 transmit the R2D signal in example 950.

FIG. 9D shows examples 960, 970, 980, and 990 of CW transmission and D2R reception in cooperative communication schemes for a group of four readers (shown as R1 710, R2 710, R3 710, and R4 710). As shown in example 960, three readers 710 (e.g., R1, R2, and R3 in example 960) may transmit a CW signal to an A-IoT device 715, and one reader 710 (e.g., R4 in example 960) may receive a D2R signal (e.g., a D2R response) from the A-IoT device 715. As shown in example 970, two readers 710 (e.g., R2 and R3 in example 970) may transmit a CW signal to an A-IoT device 715, and two readers 710 (e.g., R1 and R4 in example 970) may receive a D2R signal (e.g., a D2R response) from the A-IoT device 715. As shown in example 980, one reader 710 (e.g., R3 in example 980) may transmit a CW signal to an A-IoT device 715, and three readers 710 (e.g., R1, R2, and R4 in example 980) may receive a D2R signal (e.g., a D2R response) from the A-IoT device 715. As shown in example 990, some (e.g., one or more) readers 710 may be inactive (e.g., remain quiet) during a portion of the communication time window in which CW signal transmission and R2D signal reception are performed, and each remaining reader 710 may either transmit a CW signal to an A-IoT device 715 or receive a D2R signal (e.g., a D2R response) from the A-IoT device 715. For example, R2 710 is inactive (e.g., remains silent), R3 710 transmits the CW signal to the A-IoT device 715, and R1 710 and R4 710 receive the D2R signal from the A-IoT device 715 in example 990.

As indicated above, FIGS. 9A-9D are provided as examples. Other examples may differ from what is described with respect to FIGS. 9A-9D.

FIG. 10 is a diagram illustrating an example process 1000 performed, for example, at a network commander device or an apparatus of a network commander device, in accordance with the present disclosure. Example process 1000 is an example where the apparatus or the network commander device (e.g., network commander device 705) performs operations associated with multi-reader A-IoT operation.

As shown in FIG. 10, in some aspects, process 1000 may include receiving capability information associated with a plurality of A-IoT reader devices, the capability information indicating a respective A-IoT reader category for each A-IoT reader device of the plurality of A-IoT reader devices (block 1010). For example, the network commander device (e.g., using reception component 1202 and/or communication manager 1206, depicted in FIG. 12) may receive capability information associated with a plurality of A-IoT reader devices, the capability information indicating a respective A-IoT reader category for each A-IoT reader device of the plurality of A-IoT reader devices, as described above.

As further shown in FIG. 10, in some aspects, process 1000 may include transmitting, to the plurality of A-IoT reader devices, at least one of configuration information or scheduling information based at least in part on the capability information (block 1020). For example, the network commander device (e.g., using transmission component 1204 and/or communication manager 1206, depicted in FIG. 12) may transmit, to the plurality of A-IoT reader devices, at least one of configuration information or scheduling information based at least in part on the capability information, as described above.

Process 1000 may include additional aspects, such as any single aspect or any combination of aspects described below and/or in connection with one or more other processes described elsewhere herein.

In a first aspect, receiving the capability information includes receiving, from each A-IoT reader device of the plurality of A-IoT reader devices, a respective capability message.

In a second aspect, alone or in combination with the first aspect, the respective A-IoT reader category, for each A-IoT reader device of the plurality of A-IoT reader devices, indicates that the A-IoT reader device is a CW node, a transmit-only node, or a fully functional reader.

In a third aspect, alone or in combination with one or more of the first and second aspects, the capability information further indicates, for each A-IoT reader device of the plurality of A-IoT reader devices, at least one of a local clock accuracy capability, a carrier frequency accuracy capability, or a transmit power capability.

In a fourth aspect, alone or in combination with one or more of the first through third aspects, the configuration information indicates a synchronization signal configuration associated with a periodic synchronization signal for time and frequency synchronization of the plurality of A-IoT reader devices.

In a fifth aspect, alone or in combination with one or more of the first through fourth aspects, process 1000 includes transmitting the periodic synchronization signal in accordance with the synchronization signal configuration.

In a sixth aspect, alone or in combination with one or more of the first through fifth aspects, the configuration information or the scheduling information configures one or more groups of A-IoT reader devices, wherein each of the one or more groups of A-IoT reader devices includes multiple A-IoT reader devices of the plurality of A-IoT reader devices.

In a seventh aspect, alone or in combination with one or more of the first through sixth aspects, the one or more groups of A-IoT reader devices includes multiple non-overlapping groups of A-IoT reader devices.

In an eighth aspect, alone or in combination with one or more of the first through seventh aspects, the one or more groups of A-IoT reader devices includes a first group of A-IoT reader devices and a second group of A-IoT reader devices that overlaps with the first group of A-IoT reader devices.

In a ninth aspect, alone or in combination with one or more of the first through eighth aspects, transmitting the at least one of the configuration information or the scheduling information includes transmitting, to each A-IoT reader device included in a group of A-IoT reader devices, at least one of a dynamic indication or a static configuration indicating that the A-IoT reader device is included the group of A-IoT reader devices.

In a tenth aspect, alone or in combination with one or more of the first through ninth aspects, the one or more groups of A-IoT reader devices are based at least in part on the capability information and based at least in part on respective locations of the plurality of A-IoT reader devices.

In an eleventh aspect, alone or in combination with one or more of the first through tenth aspects, process 1000 includes receiving location information indicative of locations of one or more A-IoT reader devices of the plurality of A-IoT reader devices.

In a twelfth aspect, alone or in combination with one or more of the first through eleventh aspects, the configuration information or the scheduling information configures, for a group of A-IoT reader devices of the one or more groups of A-IoT reader devices, a cooperative communication scheme to be used by the multiple A-IoT reader devices in the group of A-IoT reader devices.

In a thirteenth aspect, alone or in combination with one or more of the first through twelfth aspects, the cooperative communication scheme configures one or more respective actions for each A-IoT reader device in the group of A-IoT reader devices in a communication time window associated with the group of A-IoT reader devices, wherein the one or more respective actions for each A-IoT reader device include one or more of transmitting an energy harvesting signal, transmitting an R2D command, transmitting a CW signal for backscattering, monitoring for a D2R response to the R2D command, remaining inactive during at least a portion of the communication time window, or communicating information with the network commander device.

In a fourteenth aspect, alone or in combination with one or more of the first through thirteenth aspects, the cooperative communication scheme configures one or more same actions, for an A-IoT reader device the group of A-IoT reader devices, in each of a plurality of communication time windows associated with the group of A-IoT reader devices.

In a fifteenth aspect, alone or in combination with one or more of the first through fourteenth aspects, the cooperative communication scheme configures one or more different actions, for an A-IoT reader device the group of A-IoT reader devices, in different communication time windows of a plurality of communication time windows associated with the group of A-IoT reader devices.

In a sixteenth aspect, alone or in combination with one or more of the first through fifteenth aspects, the cooperative communication scheme configures energy harvesting signal transmission by one or more A-IoT reader devices of the multiple A-IoT reader devices included in the group of A-IoT reader devices in a communication time window associated with the group of A-IoT reader devices.

In a seventeenth aspect, alone or in combination with one or more of the first through sixteenth aspects, the one or more A-IoT reader devices includes all of the multiple A-IoT reader devices included in the group of A-IoT reader devices.

In an eighteenth aspect, alone or in combination with one or more of the first through seventeenth aspects, the configuration information or the scheduling information indicates different tones or different carrier frequencies for respective energy harvesting signal transmissions by the one or more A-IoT reader devices.

In a nineteenth aspect, alone or in combination with one or more of the first through eighteenth aspects, the cooperative communication scheme configures transmission of an R2D command by one or more A-IoT reader devices of the multiple A-IoT reader devices included in the group of A-IoT reader devices in a communication time window associated with the group of A-IoT reader devices.

In a twentieth aspect, alone or in combination with one or more of the first through nineteenth aspects, the one or more A-IoT reader devices includes a first A-IoT reader device and a second A-IoT reader device, and the cooperative communication scheme configures a frequency shift between a transmission of the R2D command by the first A-IoT reader device and a transmission of the R2D command by the second A-IoT reader device.

In a twenty-first aspect, alone or in combination with one or more of the first through twentieth aspects, the cooperative communication scheme configures CW signal transmission, in a communication time window associated with the group of A-IoT reader devices, by one or more first A-IoT reader devices in the group of A-IoT reader devices, and reception of a backscattered D2R signal, in the communication time window associated with the group of A-IoT reader devices, by one or more second A-IoT reader devices, different from the one or more first A-IoT reader devices, in the group of A-IoT reader devices.

In a twenty-second aspect, alone or in combination with one or more of the first through twenty-first aspects, the one or more groups of A-IoT reader devices include a first group of A-IoT reader devices and a second group of A-IoT reader devices, a first A-IoT reader device is included in the first group of A-IoT reader devices and the second group of A-IoT reader devices, and the scheduling information schedules transmission, in one or more time resources, of a CW signal by the first A-IoT reader device, reception, in the one or more time resources, of a D2R signal by at least one second A-IoT reader device, other than the first A-IoT reader device, included in the first group of A-IoT reader devices, and reception, in the one or more time resources, of a D2R signal by at least one third A-IoT reader device, other than the first A-IoT reader device, included in the second group of A-IoT reader devices.

In a twenty-third aspect, alone or in combination with one or more of the first through twenty-second aspects, the one or more groups of A-IoT reader devices include a first group of A-IoT reader devices and a second group of A-IoT reader devices, the scheduling information schedules a first communication time window associated with the first group of A-IoT reader devices and a second communication time window associated with the second group of A-IoT reader devices, and the first communication time window is time division multiplexed with the second communication time window.

In a twenty-fourth aspect, alone or in combination with one or more of the first through twenty-third aspects, process 1000 includes receiving, from multiple A-IoT reader devices of the plurality of A-IoT reader devices, respective indications associated with a D2R message received from an A-IoT device by the multiple A-IoT reader devices, and transmitting an indication of a selected A-IoT reader device, of the multiple A-IoT reader devices, to transmit feedback associated with the D2R message to the A-IoT device.

In a twenty-fifth aspect, alone or in combination with one or more of the first through twenty-fourth aspects, the respective indications associated with the D2R message includes respective RSSI measurements for the D2R message, and the selected A-IoT reader device is an A-IoT reader device associated with a highest RSSI measurement, among the multiple A-IoT reader devices.

In a twenty-sixth aspect, alone or in combination with one or more of the first through twenty-fifth aspects, the configuration information indicates an RSSI threshold associated with transmission, by an A-IoT reader device of the plurality of A-IoT reader devices, of feedback associated with a D2R message received from an A-IoT device by the A-IoT reader device.

In a twenty-seventh aspect, alone or in combination with one or more of the first through twenty-sixth aspects, process 1000 includes receiving, from one or more A-IoT reader devices of the plurality of A-IoT reader devices, periodic reporting indicating one or more D2R messages with RSSI measurements that do not satisfy the RSSI threshold, and transmitting an indication of a selected A-IoT reader device, of the one or more A-IoT reader devices, to transmit feedback associated with each of the one or more D2R messages.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at an A-IoT reader device or an apparatus of an A-IoT reader device, in accordance with the present disclosure. Example process 1100 is an example where the apparatus or the A-IoT reader device (e.g., A-IoT reader device 710) performs operations associated with multi-reader A-IoT operation.

As shown in FIG. 11, in some aspects, process 1100 may include transmitting, to a network commander device, capability information associated with the A-IoT reader device, the capability information indicating an A-IoT reader category for the A-IoT reader device (block 1110). For example, the A-IoT reader device (e.g., using transmission component 1304 and/or communication manager 1306, depicted in FIG. 13) may transmit, to a network commander device, capability information associated with the A-IoT reader device, the capability information indicating an A-IoT reader category for the A-IoT reader device, as described above.

As further shown in FIG. 11, in some aspects, process 1100 may include receiving, from the network commander device, at least one of configuration information or scheduling information based at least in part on the capability information (block 1120). For example, the A-IoT reader device (e.g., using reception component 1302 and/or communication manager 1306, depicted in FIG. 13) may receive, from the network commander device, at least one of configuration information or scheduling information based at least in part on the capability information, as described above.

Process 1100 may include additional aspects, such as any single aspect or any combination of aspects described below and/or in connection with one or more other processes described elsewhere herein.

In a first aspect, the A-IoT reader category indicates that the A-IoT reader device is a CW node, a transmit-only node, or a fully functional reader.

In a second aspect, alone or in combination with the first aspect, the capability information further indicates at least one of a local clock accuracy capability for the A-IoT reader device, a carrier frequency accuracy capability for the A-IoT reader device, or a transmit power capability for the A-IoT reader device.

In a third aspect, alone or in combination with one or more of the first and second aspects, the configuration information indicates a synchronization signal configuration associated with a periodic synchronization signal for time and frequency synchronization.

In a fourth aspect, alone or in combination with one or more of the first through third aspects, process 1100 includes receiving the periodic synchronization signal in accordance with the synchronization signal configuration, and performing time and frequency synchronization based at least in part on the periodic synchronization signal.

In a fifth aspect, alone or in combination with one or more of the first through fourth aspects, the configuration information or the scheduling information indicates a group of A-IoT reader devices that includes the A-IoT reader device.

In a sixth aspect, alone or in combination with one or more of the first through fifth aspects, the group of A-IoT reader devices does not overlap with another group of A-IoT reader devices.

In a seventh aspect, alone or in combination with one or more of the first through sixth aspects, the group of A-IoT reader devices overlaps with the at least one other group of A-IoT reader devices.

In an eighth aspect, alone or in combination with one or more of the first through seventh aspects, the configuration information or the scheduling information indicates multiple groups of A-IoT reader devices that include the A-IoT reader device.

In a ninth aspect, alone or in combination with one or more of the first through eighth aspects, receiving the at least one of the configuration information or the scheduling information includes receiving at least one of a dynamic indication or a static configuration indicating that the A-IoT reader device is included the group of A-IoT reader devices.

In a tenth aspect, alone or in combination with one or more of the first through ninth aspects, the group of A-IoT reader devices that includes the A-IoT reader device is based at least in part on the capability information and based at least in part on a location of the A-IoT reader device.

In an eleventh aspect, alone or in combination with one or more of the first through tenth aspects, process 1100 includes transmitting, to the network commander device, location information indicative of the location of the A-IoT reader device.

In a twelfth aspect, alone or in combination with one or more of the first through eleventh aspects, the configuration information or the scheduling information indicates one or more actions to be performed by the A-IoT reader device in accordance with a cooperative communication scheme associated with the group of A-IoT reader devices.

In a thirteenth aspect, alone or in combination with one or more of the first through twelfth aspects, process 1100 includes performing the one or more actions in a communication time window associated with the group of A-IoT reader devices, wherein the one or more actions include one or more of transmitting an energy harvesting signal, transmitting an R2D command, transmitting a CW signal for backscattering, monitoring for a D2R response to the R2D command, remaining inactive during at least a portion of the communication time window, or communicating information with the network commander device.

In a fourteenth aspect, alone or in combination with one or more of the first through thirteenth aspects, the configuration information or the scheduling information indicates that the A-IoT reader device is to perform one or more same actions in each of a plurality of communication time windows associated with the group of A-IoT reader devices.

In a fifteenth aspect, alone or in combination with one or more of the first through fourteenth aspects, the configuration information or the scheduling information indicates that the A-IoT reader device is to perform one or more different actions in different communication time windows of a plurality of communication time windows associated with the group of A-IoT reader devices.

In a sixteenth aspect, alone or in combination with one or more of the first through fifteenth aspects, performing the one or more actions includes transmitting the energy harvesting signal in the communication time window associated with the group of A-IoT reader devices.

In a seventeenth aspect, alone or in combination with one or more of the first through sixteenth aspects, the configuration information or the scheduling information indicates a tone or a carrier frequency for the transmission of the energy harvesting signal by the A-IoT reader device.

In an eighteenth aspect, alone or in combination with one or more of the first through seventeenth aspects, performing the one or more actions includes transmitting the R2D command in the communication time window associated with the group of A-IoT reader devices.

In a nineteenth aspect, alone or in combination with one or more of the first through eighteenth aspects, the configuration information or the scheduling information configures a frequency shift between the transmission of the R2D command by the A-IoT reader device and a transmission of the R2D command by another A-IoT reader device in the group of A-IoT reader devices.

In a twentieth aspect, alone or in combination with one or more of the first through nineteenth aspects, performing the one or more actions includes transmitting the CW signal in the communication time window associated with the group of A-IoT reader devices, or receiving the D2R response in the communication time window associated with the group of A-IoT reader devices.

In a twenty-first aspect, alone or in combination with one or more of the first through twentieth aspects, the scheduling information schedules a first communication time window associated with the group of A-IoT reader devices, and the first communication time window is time division multiplexed with a second communication time window associated with another group of A-IoT reader devices.

In a twenty-second aspect, alone or in combination with one or more of the first through twenty-first aspects, process 1100 includes transmitting, to the network commander device, an indication associated with a D2R message received from an A-IoT device, and receiving, from the network commander device, an indication of whether to transmit feedback associated with the D2R message to the A-IoT device.

In a twenty-third aspect, alone or in combination with one or more of the first through twenty-second aspects, process 1100 includes transmitting, to the A-IoT device, the feedback associated with the D2R message in connection with receiving an indication to transmit the feedback to the A-IoT device.

In a twenty-fourth aspect, alone or in combination with one or more of the first through twenty-third aspects, the indication associated with the D2R message includes an RSSI measurement for the D2R message, and the indication of whether to transmit the feedback associated with the D2R message to the A-IoT device is based at least in part on the RSSI measurement.

In a twenty-fifth aspect, alone or in combination with one or more of the first through twenty-fourth aspects, the configuration information indicates an RSSI threshold, and process 1100 includes transmitting, to an A-IoT device, feedback associated with a D2R message received from the A-IoT device in connection with an RSSI measurement for the D2R message satisfying the RSSI threshold.

In a twenty-sixth aspect, alone or in combination with one or more of the first through twenty-fifth aspects, the configuration information indicates an RSSI threshold, and further comprising transmitting, to the network commander device, periodic reporting indicating one or more D2R messages with RSSI measurements that do not satisfy the RSSI threshold, and receiving, from the network commander device, an indication of whether to transmit feedback associated with each of the one or more D2R messages.

In a twenty-seventh aspect, alone or in combination with one or more of the first through twenty-sixth aspects, process 1100 includes transmitting the feedback associated with a D2R message, of the one or more D2R messages, in connection with receiving an indication to transmit the feedback associated with the D2R message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network commander, or a network commander may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 or the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 or the processing system 140 described in connection with FIG. 1) of the network commander.

In some aspects, the apparatus 1200 may be configured to perform one or more operations described herein in connection with FIGS. 7, 8A-8C, and 9A-9D. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node 110 or the UE 120 described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node 110 or the UE 120 described above in connection with FIG. 1, such as a radio, one or more RF chains, one or more transceivers, or one or more modems, each of which may in turn be coupled with one or more antennas of the network commander.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node 110 or the UE 120 described above in connection with FIG. 1, such as a radio, one or more RF chains, one or more transceivers, or one or more modems, each of which may in turn be coupled with one or more antennas of the network commander. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive capability information associated with a plurality of A-IoT reader devices, the capability information indicating a respective A-IoT reader category for each A-IoT reader device of the plurality of A-IoT reader devices. The transmission component 1204 may transmit, to the plurality of A-IoT reader devices, at least one of configuration information or scheduling information based at least in part on the capability information.

The transmission component 1204 may transmit the periodic synchronization signal in accordance with the synchronization signal configuration.

The reception component 1202 may receive location information indicative of locations of one or more A-IoT reader devices of the plurality of A-IoT reader devices.

The reception component 1202 may receive, from multiple A-IoT reader devices of the plurality of A-IoT reader devices, respective indications associated with a D2R message received from an A-IoT device by the multiple A-IoT reader devices.

The transmission component 1204 may transmit an indication of a selected A-IoT reader device, of the multiple A-IoT reader devices, to transmit feedback associated with the D2R message to the A-IoT device.

The reception component 1202 may receive, from one or more A-IoT reader devices of the plurality of A-IoT reader devices, periodic reporting indicating one or more D2R messages with RSSI measurements that do not satisfy the RSSI threshold.

The transmission component 1204 may transmit an indication of a selected A-IoT reader device, of the one or more A-IoT reader devices, to transmit feedback associated with each of the one or more D2R messages.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be an A-IoT reader device, or an A-IoT reader device may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 or the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 or the processing system 140 described in connection with FIG. 1) of the A-IoT reader device.

In some aspects, the apparatus 1300 may be configured to perform one or more operations described herein in connection with FIGS. 7, 8A-8C, and 9A-9D. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the network node 110 or the UE 120 described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node 110 or the UE 120 described above in connection with FIG. 1, such as a radio, one or more RF chains, one or more transceivers, or one or more modems, each of which may in turn be coupled with one or more antennas of the A-IoT reader device.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node 110 or the UE 120 described above in connection with FIG. 1, such as a radio, one or more RF chains, one or more transceivers, or one or more modems, each of which may in turn be coupled with one or more antennas of the A-IoT reader device. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a network commander device, capability information associated with the A-IoT reader device, the capability information indicating an A-IoT reader category for the A-IoT reader device. The reception component 1302 may receive, from the network commander device, at least one of configuration information or scheduling information based at least in part on the capability information.

The reception component 1302 may receive the periodic synchronization signal in accordance with the synchronization signal configuration.

The communication manager 1306 may perform time and frequency synchronization based at least in part on the periodic synchronization signal.

The transmission component 1304 may transmit, to the network commander device, location information indicative of the location of the A-IoT reader device.

The communication manager 1306 may perform the one or more actions in a communication time window associated with the group of A-IoT reader devices, wherein the one or more actions include one or more of transmitting an energy harvesting signal, transmitting an R2D command, transmitting a CW signal for backscattering, monitoring for a D2R response to the R2D command, remaining inactive during at least a portion of the communication time window, or communicating information with the network commander device.

The transmission component 1304 may transmit, to the network commander device, an indication associated with a D2R message received from an A-IoT device.

The reception component 1302 may receive, from the network commander device, an indication of whether to transmit feedback associated with the D2R message to the A-IoT device.

The transmission component 1304 may transmit, to the A-IoT device, the feedback associated with the D2R message in connection with receiving an indication to transmit the feedback to the A-IoT device.

The transmission component 1304 may transmit the feedback associated with a D2R message, of the one or more D2R messages, in connection with receiving an indication to transmit the feedback associated with the D2R message.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a network commander device, comprising: receiving capability information associated with a plurality of ambient internet of things (A-IoT) reader devices, the capability information indicating a respective A-IoT reader category for each A-IoT reader device of the plurality of A-IoT reader devices; and transmitting, to the plurality of A-IoT reader devices, at least one of configuration information or scheduling information based at least in part on the capability information.

Aspect 2: The method of Aspect 1, wherein receiving the capability information comprises: receiving, from each A-IoT reader device of the plurality of A-IoT reader devices, a respective capability message.

Aspect 3: The method of any of Aspects 1-2, wherein the respective A-IoT reader category, for each A-IoT reader device of the plurality of A-IoT reader devices, indicates that the A-IoT reader device is a carrier wave (CW) node, a transmit-only node, or a fully functional reader.

Aspect 4: The method of any of Aspects 1-3, wherein the capability information further indicates, for each A-IoT reader device of the plurality of A-IoT reader devices, at least one of: a local clock accuracy capability, a carrier frequency accuracy capability, or a transmit power capability.

Aspect 5: The method of any of Aspects 1-4, wherein the configuration information indicates a synchronization signal configuration associated with a periodic synchronization signal for time and frequency synchronization of the plurality of A-IoT reader devices.

Aspect 6: The method of Aspect 5, further comprising: transmitting the periodic synchronization signal in accordance with the synchronization signal configuration.

Aspect 7: The method of any of Aspects 1-6, wherein the configuration information or the scheduling information configures one or more groups of A-IoT reader devices, wherein each of the one or more groups of A-IoT reader devices includes multiple A-IoT reader devices of the plurality of A-IoT reader devices.

Aspect 8: The method of Aspect 7, wherein the one or more groups of A-IoT reader devices includes multiple non-overlapping groups of A-IoT reader devices.

Aspect 9: The method of Aspect 7, wherein the one or more groups of A-IoT reader devices includes a first group of A-IoT reader devices and a second group of A-IoT reader devices that overlaps with the first group of A-IoT reader devices.

Aspect 10: The method of any of Aspects 7-9, wherein transmitting the at least one of the configuration information or the scheduling information comprises: transmitting, to each A-IoT reader device included in a group of A-IoT reader devices, at least one of a dynamic indication or a static configuration indicating that the A-IoT reader device is included the group of A-IoT reader devices.

Aspect 11: The method of any of Aspects 7-10, wherein the one or more groups of A-IoT reader devices are based at least in part on the capability information and based at least in part on respective locations of the plurality of A-IoT reader devices.

Aspect 12: The method of Aspect 11, further comprising: receiving location information indicative of locations of one or more A-IoT reader devices of the plurality of A-IoT reader devices.

Aspect 13: The method of any of Aspects 7-12, wherein the configuration information or the scheduling information configures, for a group of A-IoT reader devices of the one or more groups of A-IoT reader devices, a cooperative communication scheme to be used by the multiple A-IoT reader devices in the group of A-IoT reader devices.

Aspect 14: The method of Aspect 13, wherein the cooperative communication scheme configures one or more respective actions for each A-IoT reader device in the group of A-IoT reader devices in a communication time window associated with the group of A-IoT reader devices, wherein the one or more respective actions for each A-IoT reader device include one or more of: transmitting an energy harvesting signal, transmitting a reader-to-device (R2D) command, transmitting a carrier wave (CW) signal for backscattering, monitoring for a device-to-reader (D2R) response to the R2D command, remaining inactive during at least a portion of the communication time window, or communicating information with the network commander device.

Aspect 15: The method of Aspect 14, wherein the cooperative communication scheme configures one or more same actions, for an A-IoT reader device the group of A-IoT reader devices, in each of a plurality of communication time windows associated with the group of A-IoT reader devices.

Aspect 16: The method of Aspect 14, wherein the cooperative communication scheme configures one or more different actions, for an A-IoT reader device the group of A-IoT reader devices, in different communication time windows of a plurality of communication time windows associated with the group of A-IoT reader devices.

Aspect 17: The method of any of Aspects 13-16, wherein the cooperative communication scheme configures energy harvesting signal transmission by one or more A-IoT reader devices of the multiple A-IoT reader devices included in the group of A-IoT reader devices in a communication time window associated with the group of A-IoT reader devices.

Aspect 18: The method of Aspect 17, wherein the one or more A-IoT reader devices includes all of the multiple A-IoT reader devices included in the group of A-IoT reader devices.

Aspect 19: The method of any of Aspects 17-18, wherein the configuration information or the scheduling information indicates different tones or different carrier frequencies for respective energy harvesting signal transmissions by the one or more A-IoT reader devices.

Aspect 20: The method of any of Aspects 13-19, wherein the cooperative communication scheme configures transmission of a reader-to-device (R2D) command by one or more A-IoT reader devices of the multiple A-IoT reader devices included in the group of A-IoT reader devices in a communication time window associated with the group of A-IoT reader devices.

Aspect 21: The method of Aspect 20, wherein the one or more A-IoT reader devices includes a first A-IoT reader device and a second A-IoT reader device, and wherein the cooperative communication scheme configures a frequency shift between a transmission of the R2D command by the first A-IoT reader device and a transmission of the R2D command by the second A-IoT reader device.

Aspect 22: The method of any of Aspects 13-21, wherein the cooperative communication scheme configures: carrier wave (CW) signal transmission, in a communication time window associated with the group of A-IoT reader devices, by one or more first A-IoT reader devices in the group of A-IoT reader devices, and reception of a backscattered device-to-reader (D2R) signal, in the communication time window associated with the group of A-IoT reader devices, by one or more second A-IoT reader devices, different from the one or more first A-IoT reader devices, in the group of A-IoT reader devices.

Aspect 23: The method of any of Aspects 7 and 9-22, wherein the one or more groups of A-IoT reader devices include a first group of A-IoT reader devices and a second group of A-IoT reader devices, wherein a first A-IoT reader device is included in the first group of A-IoT reader devices and the second group of A-IoT reader devices, and wherein the scheduling information schedules: transmission, in one or more time resources, of a CW signal by the first A-IoT reader device, reception, in the one or more time resources, of a device-to-reader (D2R) signal by at least one second A-IoT reader device, other than the first A-IoT reader device, included in the first group of A-IoT reader devices, and reception, in the one or more time resources, of a D2R signal by at least one third A-IoT reader device, other than the first A-IoT reader device, included in the second group of A-IoT reader devices.

Aspect 24: The method of any of Aspects 7-23, wherein the one or more groups of A-IoT reader devices include a first group of A-IoT reader devices and a second group of A-IoT reader devices, wherein the scheduling information schedules a first communication time window associated with the first group of A-IoT reader devices and a second communication time window associated with the second group of A-IoT reader devices, and wherein the first communication time window is time division multiplexed with the second communication time window.

Aspect 25: The method of any of Aspects 1-24, further comprising: receiving, from multiple A-IoT reader devices of the plurality of A-IoT reader devices, respective indications associated with a device-to-reader (D2R) message received from an A-IoT device by the multiple A-IoT reader devices; and transmitting an indication of a selected A-IoT reader device, of the multiple A-IoT reader devices, to transmit feedback associated with the D2R message to the A-IoT device.

Aspect 26: The method of Aspect 25, wherein the respective indications associated with the D2R message includes respective received signal strength indicator (RSSI) measurements for the D2R message, and wherein the selected A-IoT reader device is an A-IoT reader device associated with a highest RSSI measurement, among the multiple A-IoT reader devices.

Aspect 27: The method of any of Aspects 1-24, wherein the configuration information indicates a received signal strength indicator (RSSI) threshold associated with transmission, by an A-IoT reader device of the plurality of A-IoT reader devices, of feedback associated with a device-to-reader (D2R) message received from an A-IoT device by the A-IoT reader device.

Aspect 28: The method of Aspect 27, further comprising: receiving, from one or more A-IoT reader devices of the plurality of A-IoT reader devices, periodic reporting indicating one or more D2R messages with RSSI measurements that do not satisfy the RSSI threshold; and transmitting an indication of a selected A-IoT reader device, of the one or more A-IoT reader devices, to transmit feedback associated with each of the one or more D2R messages.

Aspect 29: A method of wireless communication performed by an ambient internet of things (A-IoT) reader device, comprising: transmitting, to a network commander device, capability information associated with the A-IoT reader device, the capability information indicating an A-IoT reader category for the A-IoT reader device; and receiving, from the network commander device, at least one of configuration information or scheduling information based at least in part on the capability information.

Aspect 30: The method of Aspect 29, wherein the A-IoT reader category indicates that the A-IoT reader device is a carrier wave (CW) node, a transmit-only node, or a fully functional reader.

Aspect 31: The method of any of Aspects 29-30, wherein the capability information further indicates at least one of: a local clock accuracy capability for the A-IoT reader device, a carrier frequency accuracy capability for the A-IoT reader device, or a transmit power capability for the A-IoT reader device.

Aspect 32: The method of any of Aspects 29-31, wherein the configuration information indicates a synchronization signal configuration associated with a periodic synchronization signal for time and frequency synchronization.

Aspect 33: The method of Aspect 32, further comprising: receiving the periodic synchronization signal in accordance with the synchronization signal configuration; and performing time and frequency synchronization based at least in part on the periodic synchronization signal.

Aspect 34: The method of any of Aspects 29-33, wherein the configuration information or the scheduling information indicates a group of A-IoT reader devices that includes the A-IoT reader device.

Aspect 35: The method of Aspect 34, wherein the group of A-IoT reader devices does not overlap with another group of A-IoT reader devices.

Aspect 36: The method of Aspect 34, wherein the group of A-IoT reader devices overlaps with the at least one other group of A-IoT reader devices.

Aspect 37: The method of any of Aspects 34-36, wherein the configuration information or the scheduling information indicates multiple groups of A-IoT reader devices that include the A-IoT reader device.

Aspect 38: The method of any of Aspects 34-37, wherein receiving the at least one of the configuration information or the scheduling information comprises: receiving at least one of a dynamic indication or a static configuration indicating that the A-IoT reader device is included the group of A-IoT reader devices.

Aspect 39: The method of any of Aspects 34-38, wherein the group of A-IoT reader devices that includes the A-IoT reader device is based at least in part on the capability information and based at least in part on a location of the A-IoT reader device.

Aspect 40: The method of Aspect 39, further comprising: transmitting, to the network commander device, location information indicative of the location of the A-IoT reader device.

Aspect 41: The method of any of Aspects 34-40, wherein the configuration information or the scheduling information indicates one or more actions to be performed by the A-IoT reader device in accordance with a cooperative communication scheme associated with the group of A-IoT reader devices.

Aspect 42: The method of Aspect 41, further comprising performing the one or more actions in a communication time window associated with the group of A-IoT reader devices, wherein the one or more actions include one or more of: transmitting an energy harvesting signal, transmitting a reader-to-device (R2D) command, transmitting a carrier wave (CW) signal for backscattering, monitoring for a device-to-reader (D2R) response to the R2D command, remaining inactive during at least a portion of the communication time window, or communicating information with the network commander device.

Aspect 43: The method of Aspect 42, wherein the configuration information or the scheduling information indicates that the A-IoT reader device is to perform one or more same actions in each of a plurality of communication time windows associated with the group of A-IoT reader devices.

Aspect 44: The method of Aspect 42, wherein the configuration information or the scheduling information indicates that the A-IoT reader device is to perform one or more different actions in different communication time windows of a plurality of communication time windows associated with the group of A-IoT reader devices.

Aspect 45: The method of any of Aspects 42-44, wherein performing the one or more actions comprises: transmitting the energy harvesting signal in the communication time window associated with the group of A-IoT reader devices.

Aspect 46: The method of Aspect 45, wherein the configuration information or the scheduling information indicates a tone or a carrier frequency for the transmission of the energy harvesting signal by the A-IoT reader device.

Aspect 47: The method of any of Aspects 42-46, wherein performing the one or more actions comprises: transmitting the R2D command in the communication time window associated with the group of A-IoT reader devices.

Aspect 48: The method of Aspect 47, wherein the configuration information or the scheduling information configures a frequency shift between the transmission of the R2D command by the A-IoT reader device and a transmission of the R2D command by another A-IoT reader device in the group of A-IoT reader devices.

Aspect 49: The method of any of Aspects 42-48, wherein performing the one or more actions comprises: transmitting the CW signal in the communication time window associated with the group of A-IoT reader devices; or receiving the D2R response in the communication time window associated with the group of A-IoT reader devices.

Aspect 50: The method of any of Aspects 34-49, wherein the scheduling information schedules a first communication time window associated with the group of A-IoT reader devices, and wherein the first communication time window is time division multiplexed with a second communication time window associated with another group of A-IoT reader devices.

Aspect 51: The method of any of Aspects 29-50, further comprising: transmitting, to the network commander device, an indication associated with a device-to-reader (D2R) message received from an A-IoT device; and receiving, from the network commander device, an indication of whether to transmit feedback associated with the D2R message to the A-IoT device.

Aspect 52: The method of Aspect 51, further comprising: transmitting, to the A-IoT device, the feedback associated with the D2R message in connection with receiving an indication to transmit the feedback to the A-IoT device.

Aspect 53: The method of any of Aspects 51-52, wherein the indication associated with the D2R message includes a received signal strength indicator (RSSI) measurement for the D2R message, and wherein the indication of whether to transmit the feedback associated with the D2R message to the A-IoT device is based at least in part on the RSSI measurement.

Aspect 54: The method of any of Aspects 29-50, wherein the configuration information indicates a received signal strength indicator (RSSI) threshold, and further comprising: transmitting, to an A-IoT device, feedback associated with a device-to-reader (D2R) message received from the A-IoT device in connection with an RSSI measurement for the D2R message satisfying the RSSI threshold.

Aspect 55: The method of any of Aspects 29-54, wherein the configuration information indicates a received signal strength indicator (RSSI) threshold, and further comprising: transmitting, to the network commander device, periodic reporting indicating one or more device-to-reader (D2R) messages with RSSI measurements that do not satisfy the RSSI threshold; and receiving, from the network commander device, an indication of whether to transmit feedback associated with each of the one or more D2R messages.

Aspect 56: The method of Aspect 55, further comprising: transmitting the feedback associated with a D2R message, of the one or more D2R messages, in connection with receiving an indication to transmit the feedback associated with the D2R message.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-56.

Aspect 58: An apparatus for wireless communication at a device, the apparatus comprising one or more memories and one or more processors coupled to the one or more memories, the one or more processors configured to cause the device to perform the method of one or more of Aspects 1-56.

Aspect 59: An apparatus for wireless communication, the apparatus comprising at least one means for performing the method of one or more of Aspects 1-56.

Aspect 60: A non-transitory computer-readable medium storing code for wireless communication, the code comprising instructions executable by one or more processors to perform the method of one or more of Aspects 1-56.

Aspect 61: A non-transitory computer-readable medium storing a set of instructions for wireless communication, the set of instructions comprising one or more instructions that, when executed by one or more processors of a device, cause the device to perform the method of one or more of Aspects 1-56.

Aspect 62: A device for wireless communication, the device comprising a processing system that includes one or more processors and one or more memories coupled with the one or more processors, the processing system configured to cause the device to perform the method of one or more of Aspects 1-56.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software.

The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network commander device for wireless communication, comprising:
one or more memories; and
one or more processors coupled to the one or more memories, the one or more processors individually or collectively configured to:
receive capability information associated with a plurality of ambient internet of things (A-IoT) reader devices, the capability information indicating a respective A-IoT reader category for each A-IoT reader device of the plurality of A-IoT reader devices; and
transmit, to the plurality of A-IoT reader devices, at least one of configuration information or scheduling information based at least in part on the capability information.

2. The network commander device of claim 1, wherein the one or more processors, to receive the capability information, are individually or collectively configured to: receive, from each A-IoT reader device of the plurality of A-IoT reader devices, a respective capability message.

3. The network commander device of claim 1, wherein the respective A-IoT reader category, for each A-IoT reader device of the plurality of A-IoT reader devices, indicates that the A-IoT reader device is a carrier wave (CW) node, a transmit-only node, or a fully functional reader.

4. The network commander device of claim 1, wherein the capability information further indicates, for each A-IoT reader device of the plurality of A-IoT reader devices, at least one of:
a local clock accuracy capability,
a carrier frequency accuracy capability, or
a transmit power capability.

5. The network commander device of claim 1, wherein the configuration information indicates a synchronization signal configuration associated with a periodic synchronization signal for time and frequency synchronization of the plurality of A-IoT reader devices.

6. The network commander device of claim 5, wherein the one or more processors are individually or collectively configured to:
transmit the periodic synchronization signal in accordance with the synchronization signal configuration.

7. The network commander of claim 1, wherein the configuration information or the scheduling information configures one or more groups of A-IoT reader devices, wherein each of the one or more groups of A-IoT reader devices includes multiple A-IoT reader devices of the plurality of A-IoT reader devices.

8. The network commander of claim 7, wherein the one or more groups of A-IoT reader devices are based at least in part on the capability information and based at least in part on respective locations of the plurality of A-IoT reader devices.

9. The network commander of claim 8, wherein the one or more processors are individually or collectively configured to:
receive location information indicative of locations of one or more A-IoT reader devices of the plurality of A-IoT reader devices.

10. The network commander of claim 7, wherein the configuration information or the scheduling information configures, for a group of A-IoT reader devices of the one or more groups of A-IoT reader devices, a cooperative communication scheme to be used by the multiple A-IoT reader devices in the group of A-IoT reader devices.

11. The network commander of claim 10, wherein the cooperative communication scheme configures one or more respective actions for each A-IoT reader device in the group of A-IoT reader devices in a communication time window associated with the group of A-IoT reader devices, wherein the one or more respective actions for each A-IoT reader device include one or more of:
transmitting an energy harvesting signal,
transmitting a reader-to-device (R2D) command,
transmitting a carrier wave (CW) signal for backscattering,
monitoring for a device-to-reader (D2R) response to the R2D command,
remaining inactive during at least a portion of the communication time window, or
communicating information with the network commander device.

12. The network commander of claim 10, wherein the cooperative communication scheme configures energy harvesting signal transmission by one or more A-IoT reader devices of the multiple A-IoT reader devices included in the group of A-IoT reader devices in a communication time window associated with the group of A-IoT reader devices.

13. The network commander of claim 12, wherein the one or more A-IoT reader devices includes all of the multiple A-IoT reader devices included in the group of A-IoT reader devices.

14. The network commander of claim 12, wherein the configuration information or the scheduling information indicates different tones or different carrier frequencies for respective energy harvesting signal transmissions by the one or more A-IoT reader devices.

15. The network commander of claim 10, wherein the cooperative communication scheme configures transmission of a reader-to-device (R2D) command by one or more A-IoT reader devices of the multiple A-IoT reader devices included in the group of A-IoT reader devices in a communication time window associated with the group of A-IoT reader devices.

16. The network commander of claim 15, wherein the one or more A-IoT reader devices includes a first A-IoT reader device and a second A-IoT reader device, and wherein the cooperative communication scheme configures a frequency shift between a transmission of the R2D command by the first A-IoT reader device and a transmission of the R2D command by the second A-IoT reader device.

17. The network commander of claim 10, wherein the cooperative communication scheme configures:
carrier wave (CW) signal transmission, in a communication time window associated with the group of A-IoT reader devices, by one or more first A-IoT reader devices in the group of A-IoT reader devices, and
reception of a backscattered device-to-reader (D2R) signal, in the communication time window associated with the group of A-IoT reader devices, by one or more second A-IoT reader devices, different from the one or more first A-IoT reader devices, in the group of A-IoT reader devices.

18. The network commander of claim 7, wherein the one or more groups of A-IoT reader devices include a first group of A-IoT reader devices and a second group of A-IoT reader devices, wherein the scheduling information schedules a first communication time window associated with the first group of A-IoT reader devices and a second communication time window associated with the second group of A-IoT reader devices, and wherein the first communication time window is time division multiplexed with the second communication time window.

19. An ambient internet of things (A-IoT) reader device for wireless communication, comprising:
one or more memories; and
one or more processors coupled to the one or more memories, the one or more processors individually or collectively configured to:
transmit, to a network commander device, capability information associated with the A-IoT reader device, the capability information indicating an A-IoT reader category for the A-IoT reader device; and
receive, from the network commander device, at least one of configuration information or scheduling information based at least in part on the capability information.

20. A method of wireless communication performed by a network commander device, comprising:
receiving capability information associated with a plurality of ambient internet of things (A-IoT) reader devices, the capability information indicating a respective A-IoT reader category for each A-IoT reader device of the plurality of A-IoT reader devices; and
transmitting, to the plurality of A-IoT reader devices, at least one of configuration information or scheduling information based at least in part on the capability information.
